(19) United States
(12) Patent Application Publication
(10) Pub. No.: US 2007/0129971 A1
(43) Pub. Date: Jun. 7, 2007

(54) System and method for automated management and training in custom home design and build projects

(76) Inventors: Robert Vernon McLemore, Charlotte, NC (US); Christine M. Carriker, Indian Trail, NC (US); Grant S. Neerings, Charlotte, NC (US)

Correspondence Address: OSTROLENK FABER GERB & SOFFEN, 1180 AVENUE OF THE AMERICAS, NEW YORK, NY, 100368403, US

(21) Appl. No.: 11/593,820

(22) Filed: Nov. 7, 2006

Related U.S. Application Data
(60) Provisional application No. 60/734,234, filed on Nov. 7, 2005.

(51) Int. Cl. G06Q 40/00

(52) U.S. Cl. 705/4

(57) ABSTRACT

The invention includes a system and method for using a database to sell a custom home project to a buyer. Electronic construction information related to specifications and costs associated with a plurality of projects is stored in the database. Further, electronic construction information related to specifications and costs associated with custom features of the projects is stored. Buyer rules are defined to be applied in selling one of the projects. The buyer rules include obtaining buyer financial information that represents the financial ability of the buyer, obtaining personal information that represents whether the buyer is personally able to purchase the one project, retrieving from the database first electronic construction information related to the one project, retrieving from the database second electronic construction information related to at least one custom feature to be included in the project, and determining whether the buyer is able to afford the one project financially. Moreover, electronic buyer rule information representing the buyer rules is stored in the database and the electronic buyer rule information is formatted to be retrievable upon request. Further a party selling the one project is trained to learn and apply buyer rules, wherein the training includes displaying the electronic buyer rule information on a computing device, wherein the party sells the one project to the buyer by applying the buyer rules and determining that the buyer is personally and financially able to purchase the one project.

### CROSS-REFERENCE TO RELATED APPLICATIONS

This patent application is based upon and claims priority to U.S. provisional patent application Ser. No. 60/734,234, filed Nov. 7, 2005, entitled SYSTEM AND METHOD FOR AUTOMATED MANAGEMENT AND ON-LINE ACADEMIC INSTITUTION FOR CUSTOM HOME DESIGN AND BUILT PROJECTS, the entirety of which is incorporated herein by reference. The present patent application also incorporates by reference the entirety of U.S. patent application Ser. No. 11/029,569, filed Jan. 5, 2005 and entitled SYSTEM AND METHOD FOR AUTOMATED MANAGEMENT OF CUSTOM HOME DESIGN AND BUILD PROJECTS, as if set forth fully herein.

### BACKGROUND OF THE INVENTION

1. Field Of The Invention

The present invention relates generally to custom home building, and, more specifically, to ensuring proper training, support and management for a plurality of parties associated with a custom home design and build project.

2. Description of the Related Art

Complexities associated with negotiating and managing custom home design and building projects are numerous. In large part, this is due to specialized and distinctly different professionals who design, construct and finance custom home design and build projects. Further, there are many different kinds of homebuyers who have varying expectations and varying means for realizing their custom dream homes. For example, homebuyers, builders, designers, sub-contractors, materials suppliers, financial representatives and attorneys interact to provide services during custom homebuilding. In the prior art, parties associated with custom home design and build projects operate independently and provide services that often give rise to dissatisfaction and/or liability, and that are unique to their respective industries. Although no central management of the parties associated in the custom home design and build project is provided for in the prior art, homebuilders are usually found legally responsible for the actions of parties not under builders' direct management or control.

One frequent complaint made by buyers of custom home design and build projects is related to mismanagement of time. For example, a plumber is scheduled to provide plumbing services during week #8, and an installer of sheet rock is scheduled for week #9. If the plumber does not meet the week #8 schedule, the sheet rock installer is delayed and may not be available again for weeks after week #9. Such time delays frequently occur when a builder loses control of subcontractors and is unsuccessful in holding them to strict schedules. It is not uncommon for a building job, for example, plumbing, to stretch from two weeks to complete to two months.

Other complaints received from buyers of custom home design and build projects regard absenteeism of the parties who negotiated a deal with the owners. In such cases, oversight of the project is left to a party who was not initially involved. This activity occurs, typically, during custom home design and build projects involving large custom homebuilders, and results in mistakes made by subcontractors and/or vendors. For example, locations of electrical outlets and water faucets, incorrect window locations, location and details of cabinets and fixtures, incorrect paint shades and improper lot grading are mistakes typically complained of by buyers of custom homes.

Small custom homebuilders purportedly offer more personal contact with the homebuyer. Unfortunately, while their creative and personal skills may provide more attention to details and may be somewhat superior to that of superintendents employed by the large custom homebuilders, small custom homebuilders typically do not have control over the projects. If the builder is not in control, problems develop and costs increase, making the small homebuilders more vulnerable to financial failures. Moreover and due to their size, small builders do not have access to volume discounts on many supplies that materials suppliers give to large builders, making the business of providing value more difficult.

A custom homebuyer typically begins the buying process with a dream of a new home. When the architect begins designing the house with the homebuyer, the homebuyer's budget in not usually the driving force at that stage of the custom process. Designers are paid to design the home, usually more interested in creating a unique home design and not as concerned about the costs of building the home. The homebuyers do not know the true costs of the home they designed until they meet with the builders. For example, the costs of plans and specifications invested in designing the unique home is not usually tied to the costs of building the home.

Homebuyers meet with builders that are forced to locate ways of reducing costs of the home design. The process becomes a function of limiting specifications and choices. For example, a homebuyer may be able to afford a home that is 3,500 square feet, but can only afford a vinyl exterior rather than, for example, stone or brick. Once the builder and the buyer decide upon the particulars of the custom home, a contract is signed that binds the parties to the construction of the new home. Often homebuyers are forced to have several home plans designed before settling on a plan that they can afford.

After construction of a custom home begins, issues often arise which frequently prevent the builder from completing the project within the estimated budget. For example, architectural plans do not conform to standard material sizes, resulting in material waste and excessive costs. Moreover, unexpected increases of the cost of materials, supplies, and other ancillary expenses during the course of a project results in the inability of the builder to keep the project within the estimated budget.

One way that builders try to maintain an estimated budget throughout the custom homebuilding process is to artificially inflate the cost of the project during the initial development of the project. Rather than absorbing costs that can't be foreseen, the builder increases the entire budget by an arbitrary amount, for example, 15% of the total cost of the project.

A frequent conflict occurring in the prior art between homebuilders and homebuyers regards management of capital. Typically, either funds are drawn for services not yet completed, or funds are held until the party in control of the funds decides to release them. In either case, conflict arises because services are either not performed or capital is not provided for services that have been performed.

Another common conflict occurring in the prior art regards one or more tasks that require completion even though the new construction is suitable for occupancy or has been taken physical possession by the homebuyer. For example, fixtures may require adjustments, room colors may be incorrectly painted, incorrect trim may be applied or other mistakes or problems that are not resolved during construction remain outstanding. It is not uncommon for homebuyers to withhold funds from builders because of lingering issues with respect to completion of the new home. In these conflicts, buyers may use funds unfairly as leverage against builders to force completion of various tasks. Moreover, the amount of money that the buyer withholds as leverage may far exceed the value of services and materials that are required for completion. The buyer may believe that such leverage will force the homebuilder to complete the tasks. When money is withheld as leverage, builders may be unable to pay the final bills due on a home project, thus liens appear which add financial problems for homebuyers and builders.

Another problem that occurs in a prior art custom home design and build project regards contracts in which the builder is agrees to a fixed fee. Often in the prior art, sub-contractors and vendors who work for small homebuilders are not parties to the new home contracts. These vendors usually make adjustments to the prices in the months when fees are charged to builders, and are seldom willing to quote fixed prices months in advance. Because the vendor is outside of the contract, it is unlikely the small homebuilder can obtain price protection on these projects, thus, the cost of the project often increases, resulting in financial disasters for the builders.

The prior art fixed fee arrangement is flawed because the responsible party in the project (i.e., the small builder) cannot reasonably predict the outcome of the projects that have been contracted with homebuyers. Homebuyers and homebuilders continue to develop fixed price contracts on home projects that cannot be predicted. The inability to predict costs for these projects forces a high percentage of the projects into conflict. When the prior art process fails, the results are liens, lawsuits and financial nightmares for homebuyers and builders alike. Alternatively, homebuyers are charged exorbitant rates so that the builder is ensured eventually making a profit.

Computer hardware and software applications have been developed to assist both custom homebuilders and buyers during custom homebuilding. These automated solutions, however, do not offer an integrated, on-line package that is used by all of the parties to new home construction. During the last decade in particular, custom homebuyers have been offered computerized homebuilding management programs whereby individuals acquire software that reportedly prepares them to manage the building of their own homes. The marketing scheme presented in these homebuilding programs is that homebuyers can use the software to eliminate builder profits from their projects. Though it is believed some of software applications result in savings for some, overwhelmingly, these “build your own home” programs fail to meet the needs of most homebuyers. In fact, the homebuyers that are most attracted to costs savings from these build your own home programs are typically the individuals that can least afford the financial risks. Thus, the fallacy that homebuyers experience in choosing build it yourself software programs stems from unpredictable costs described above. Further, in such build your own home scenarios, vendors realize that the project is a one time effort, and thus have little to no incentive to be competitive, both in price and scheduling. The homebuyer typically spends a large part of their reported cost savings in overcharges from unrelated vendors.

Thus, in the prior art, custom homebuyers seeking to fulfill a dream of owning a custom designed home enter into contracts with false expectations. From being required to invest in plans without knowing the cost of building the home, to selecting the right builder, custom homebuyers are not adequately prepared to undertake the process of designing and building their own home. For example, most custom homebuyers order house plans from magazines before lots are selected and invest in custom design modifications without knowledge of the actual cost to build the custom design.

U.S. patent application, Ser. No. 11/029,569 (the '569 patent application), which is assigned to the assignee of the present patent application, addresses and resolves these and other prior art shortcomings. The '569 patent application defines a system and method for managing parties and tasks associated with the design, construction, contracting to purchase custom designed and built homes. Particularly, a plurality of computer-related applications preferably receive, process and transmit information to and from builders, subcontractors, homebuyers regarding the building of custom built homes. The custom home design and build process is managed, in part, by providing inter-parties communication, and by providing specific directives to all parties associated with constructing a custom home. Further, custom home build and design projects are monitored from initial conversations to months after completion, thereby ensuring that expectations are clearly defined and met.

By managing the parties associated with a custom home design and build project, expectations are clearly defined and met by ensuring parties are held responsible, for example, contractually binding the parties in order to ensure that expectations are reasonable and are met.

### SUMMARY OF THE INVENTION

It is recognized by the inventors that strict adherence to the system and method defined the '569 patent application improves the ability for the invention described therein to work. In particular, if parties do not submit information properly or in a timely fashion, then an ability to make an accurate prediction of the cost of labor and materials for a custom homebuilding design and project is compromised.

Accordingly, the present invention provides a system and method for parties to receive proper training for tasks associated with custom home design and build projects, and for proper use of the system and method of the invention defined in the '569 patent application. The business method and system include training parties to properly use the invention disclosed in the '569 patent, such that the parties learn to enter accurate data and to retrieve the data in useful ways. Further, by receiving proper training provide by the present invention, the particular tasks associated with successful custom home design and build projects are similarly ensured.

In a preferred embodiment, the present invention includes a system and method for using a database to sell a custom home design and build project to a buyer. First electronic construction information related to specifications and costs associated with a plurality of custom home design and build projects is stored in the database. Further, second electronic construction information related to specifications and costs associated with custom features for the plurality of the projects is stored in the database.

Further, buyer rules are defined to be applied in selling one of the projects. The buyer rules preferably include obtaining buyer financial information from the buyer that represents the financial ability of the buyer, obtaining personal information from the buyer that represents whether the buyer is personally able to purchase the one project, retrieving from the database first electronic construction information related to the one project, retrieving from the database second electronic construction information related to at least one custom feature to be included in the project, and determining whether the buyer is able to afford the one project financially.

Moreover, electronic buyer rule information representing the buyer rules is stored in the database and the electronic buyer rule information is formatted to be retrievable upon request. Further a party selling the one project is trained to learn and apply buyer rules, wherein the training includes displaying the electronic buyer rule information on a computing device, wherein the party sells the one project to the buyer by applying the buyer rules and determining that the buyer is personally and financially able to purchase the one project.

Other features and advantages of the present invention will become apparent from the following description of the invention, which refers to the accompanying drawings.

### BRIEF DESCRIPTION OF THE DRAWINGS

For the purposes of illustrating the invention, there is shown in the drawings a form which is presently preferred, it being understood, however, that the invention is not limited to the precise arrangements and instrumentalities shown. The features and advantages of the present invention will become apparent from the following description of the invention that refers to the accompanying drawings, in which:

FIG. 1 a diagram of an example custom homebuilding management system constructed in accordance with the present invention;

FIG. 2 is a block diagram of the functional elements of a network connecting device used in accordance with the present invention;

FIG. 3 illustrates parties and devices constructed in accordance with the present invention;

FIG. 4 is a flow chart illustrating steps associated with management platform 1 in accordance with a preferred embodiment of the present invention;

FIG. 4A is an example display screen that illustrates a data entry form used for submitting information corresponding to contacting and consulting potential custom homebuyers;

FIG. 5 is a flow chart illustrating steps associated with a custom home design team meeting with a prospect, in accordance with a preferred embodiment;

FIG. 5A is an example display screen that illustrates a data entry form used for submitting information corresponding to designing and developing specifications for a custom home design and build project;

FIG. 6 is a flow chart illustrating steps associated with coordinating building details, building vendors and operating budget, in accordance with a preferred embodiment;

FIG. 6A is an example display screen that illustrates a data entry form used for submitting information corresponding to coordinating builders, vendors, and budgets associated with a custom home design and build project;

FIG. 7 is a flow chart illustrating steps associated with managing the cash flow of a custom home design and build project;

FIG. 7A is an example display screen of a data entry form used for submitting information corresponding to managing cash flow for a custom home design and build project;

FIG. 8 is a flow chart illustrating steps associated with managing the building process associated with a custom home design and build project;

FIG. 8A is an example display screen of a data entry form used for submitting information corresponding to managing building processes associated with a custom home design and build project;

FIG. 8B illustrates an example display screen that provides graphical screen controls and displays for a party to monitor a custom home design and build project;

FIG. 9 is a flow chart that illustrates steps associated with completion of a custom home design and build project;

FIG. 9A is an example display screen of a data entry form used for submitting information corresponding to managing the closing process and post closing processes in a custom home design and build project;

FIG. 10 is an example display screen and illustrates the use of on-line tool-tips provided in accordance with a preferred embodiment of the present invention;

FIG. 11 illustrates an example on-line training screen that provides general training for personnel in giving a two-minute presentation;

FIGS. 12A and 12B illustrate example display screens for training personnel to submit information corresponding to respective data entry screens;

FIG. 13 illustrates an example display screen showing a multi-media training presentation;

FIG. 14 illustrates another example display screen that presents a multi-media training presentation;

FIG. 15 illustrates an example classroom provided in accordance with the present invention; and

FIG. 16 illustrates an example test display screen that is used to gauge a student's or trainee's knowledge of a particular subject area.

### DESCRIPTION OF THE INVENTION

The present invention enables parties to receive proper training for managing and completing tasks associated with custom home design and build projects. In particular, parties use the present invention to learn to electronically submit information into an intemet-based software application that associated with a custom home design and build project. The present invention further provides training for custom homebuilders to comply with building standards set by a proprietor of the present invention, which are preferably higher than defined in building codes and legal. Thus, the present invention provides training in the use of a custom home design and build project software, as well as in the actual tasks required for successful completion of the custom home design and build project. Proper training provided by the present invention ensures an accurate prediction of the cost of labor and materials for the custom home design and build project.

The present invention further provides a formatted set of management platforms (described below), and tasks or phases associated therewith that, when adhered to, assures successful completion of custom home design and build projects, as well as extremely accurate predictions of costs and time for completing a custom home design and build project.

As used herein, the term “web site” refers to a related set of files which are maintained in one or more computer systems, referred to as “web servers” and which, when transmitted to a user terminal, cause a user terminal to display and/or execute programmatic operations corresponding to the data contained in the files. Typically, the files comprising the web site are prepared using one or more of a combination of Hyptertext Mark-Up Language (HTML), Extendable Mark-Up Language (XML), Java Applets, ActiveX programs, Standard Generalized Mark-Up Language (SGML) files and the like. Web site files are typically transmitted to a user terminal using one or more protocols, such as the Hyptertext Transfer Protocol (HTTP) under the Transmission Control Protocol/Internet Protocol (TCP/IP) suite of communication protocols.

Also as used herein, the term “browser” refers to an application program residing and executing on a user terminal which functions as an HTTP client, sending requests to web servers for web site files. A request is typically sent in the form of a Uniform Resource Locator (URL) or by selecting a hypertext link presented on the user terminal display. The browser functions to format the file and/or data received from the web server and format the received files and/or data in the manner described therein, displaying the same on the user terminal. Examples of browser programs include MICROSOFT INTERNET EXPLORER and NETSCAPE NAVIGATOR.

As used herein, the term “link” refers to a selectable connection from one or more words, pictures or other information objects to others in which the selectable connection is presented within the web browser. The information object can include sound and/or motion video. Selection is typically made by “clicking” on the link using an input device such as a mouse, track ball and the like. Of course, one of ordinary skill in the art will appreciate that any method by which an object presented on the screen can be selected is sufficient.

Also as used herein, the term, “construction project” refers, generally, to any building activity. For example, a construction project may include construction of a new custom house or other structure. Alternatively, a construction project may refer to a renovation of an existing, such as, for example, an addition made to a house. Thus, a construction project is not intended to be limited to new buildings or modification to existing buildings.

As used herein, the term, “module,” refers, generally, to one or more discrete components that contribute to the effectiveness of the present invention. Modules can include software elements, including but not limited to functions, algorithms, classes and the like. Modules also include hardware elements, substantially as described below. Modules can operate independently or, alternatively, depend upon one or more other modules in order to function.

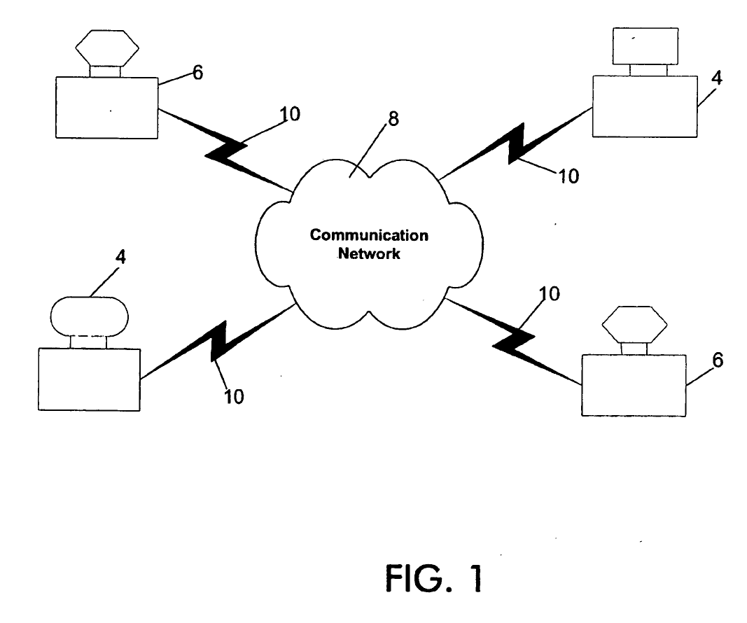

Referring now to the drawings figures in which like reference numerals refer to like elements, there is shown in FIG. 1 a diagram of an example custom homebuilding management system constructed in accordance with the present invention, and designated generally as “custom home design and building management system 2.” Custom homebuilding management system 2 is preferably comprised of one or more site processors 4 coupled to one or more workstations 6 across communication network 8.

Site processor 4 preferably includes all necessary databases for the present invention. However, it is contemplated that site processor 4 can access any required databases via communication network 8 or any other communication network to which site processor 4 has access. Site processor 4 can communicate devices comprising databases using any known communication method, including a direct serial or parallel interface, or via a local or wide area network.

Workstations 6 communicate with site processors 4 using data connections 10, which are respectively coupled to communication network 8. Communication network 8 can be any communication network, but is typically the Internet or some other global computer network. Data connections 10 can be any known arrangement for accessing communication network 8, such as dial-up serial line interface protocol/point-to-point protocol (SLIPP/PPP), integrated services digital network (ISDN), dedicated leased-line service, broadband (cable) access, frame relay, digital subscriber line (DSL), asynchronous transfer mode (ATM) or other access techniques.

Workstations 6 preferably have the ability to send and receive data across communication network 8, and are equipped with web browsers to display the received data on display devices incorporated therewith. By way of example, workstation 6 may be personal computers such as Intel Pentium-class computers or Apple Macintosh computers, but are not limited to such computers. Other terminals which can communicate over a global computer network such as palmtop computers, personal digital assistants (PDAs) and mass-marketed Internet access devices such as WebTV can be used. In addition, the hardware arrangement of the present invention is not limited to devices that are physically wired to communication network 8. Of course, one skilled in the art will recognize that wireless devices can communicate with site processors 4 using wireless data communication connections (e.g., WIFI).

In addition to computer-related methods to access the system, parties who are not able to access the custom homebuilding management system 2 via a computer or related device can write physical letters, make telephone calls or facsimiles to parties operating in accordance with the present invention. For example, after a letter and/or telephone call is received, data-entry personnel make the necessary entries into custom homebuilding management system 2.

According to the present invention, workstation 6 provides user access to site processor 4 for the purpose of receiving and providing custom homebuilding-related information. The specific functionality provided by custom homebuilding management system 2, and in particular site processors 4, is described in detail below.

Custom homebuilding management system 2 employs software that controls custom homebuilding management functions and preferably resides on one or more site processors 4. One of the functions performed by site processor 4 is that of operating as a web server and/or a web site host. Site processors 4 typically communicate with communication network 8 across a permanent i.e., unswitched data connection 10. Permanent connectivity ensures that access to site processors 4 is always available.

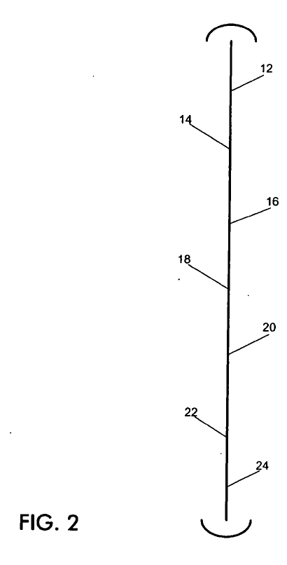

As shown in FIG. 2 the functional elements of each site processor 4 preferably include one or more central processing units (CPU) 12 used to execute software code in order to control the operation of site processor 4, read only memory (ROM) 14, random access memory (RAM) 16, one or more network interfaces 18 to transmit and receive data to and from other computing devices across a communication network, storage devices 20 such as a hard disk drive, floppy disk drive, tape drive, CD-ROM or DVD drive for storing program code, databases and application code, one or more input devices 22 such as a keyboard, mouse, track ball and the like, and a display 24.

The various components of site processor 4 need not be physically contained within the same chassis or even located in a single location. For example, as explained above with respect to databases which can reside on storage device 20, storage device 20 may be located at a site which is remote from the remaining elements of site processors 4, and may even be connected to CPU 12 across communication network 8 via network interface 18.

The functional elements shown in FIG. 2 (designated by reference numbers 12-24) are preferably the same categories of functional elements preferably present in workstation 6. However, not all elements need be present, for example, storage devices in the case of PDAs, and the capacities of the various elements are arranged to accommodate expected user demand. For example, CPU 12 in workstation 6 may be of a smaller capacity than CPU 12 as present in site processor 4. Similarly, it is likely that site processor 4 will include storage devices 20 of a much higher capacity than storage devices 20 present in work station 6. Of course, one of ordinary skill in the art will understand that the capacities of the functional elements can be adjusted as needed.

The nature of the present invention is such that one skilled in the art of writing computer executed code (software) can implement the described functions using one or more or a combination of a popular computer programming language including but not limited to “C++”, Visual Basic, Java, ActiveX, HTML, and web application development environments.

As used herein, references to displaying data on workstation 6 refer to the process of communicating data to the terminal across communication network 8 and processing the data such that the data can be viewed on the work station display 24 using a web browser or the like. The display screen on terminal 6 present areas within custom homebuilding management system 2 such that a user can proceed from area to area within the custom homebuilding management system 2 by selecting a desired link. Therefore, each user's experience with custom homebuilding management system 2 will be based on the order with which they progress through the display screens. In other words, because the system is not completely hierarchical in its arrangement of display screens, users can proceed from area to area without the need to “backtrack” through a series of display screens. For that reason, unless stated otherwise, the following discussion is not intended to represent any sequential operation steps, but rather the discussion of the components of custom homebuilding management system 2.

Although the present invention is described by way of example herein in terms of a web-based system using web browsers and a web site server (site processor 4), custom homebuilding management system 2 is not limited to that particular configuration. It is contemplated that custom homebuilding management system 2 can be arranged such that work station 6 can communicate with, and display data received from, site processor 4 using any known communication and display method, for example, using a non-Internet browser Windows viewer coupled with a local area network protocol such as the Internetwork Packet Exchange (IPX). It is further contemplated that any suitable operating system can be used on workstation 6, for example, Windows 3.x, Windows 95, Windows 98, Windows CE, Windows NT, LINUX and any suitable PDA or palm computer operating system.

Referring now to tasks associated with custom homebuilding, in a preferred embodiment, similar tasks are organized in six categories, wherein each category requires a specific skill set that contributes to a successful completion of a custom home design and build project. The categories are referred to herein, generally, as management platforms (“MP”), and are labeled referred to herein as MP1-MP6, respectively. The management platforms represent skills associated with custom home design and build projects, and include consulting, creating, coordinating, managing cash flow, providing construction and closing services. Each are described in greater detail below.

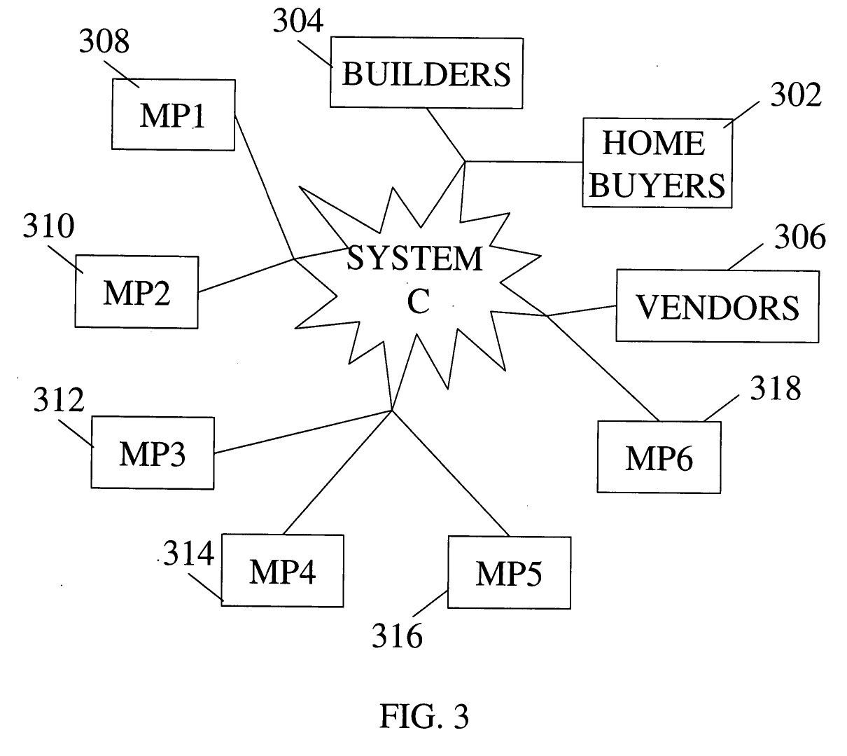

FIG. 3 shows an arrangement of parties and associated with designing and building a custom home in accordance with the present invention. As shown in FIG. 3, custom homebuyers 302, custom homebuilders 304, vendors 306, and management platform personnel (MP1 personnel 308, MP2 personnel 310, MP3 personnel 312, MP4 personnel 314, MP5 personnel 316, and MP6 personnel 318) all preferably interact and are managed via an interactive internet based software application, referred to herein, generally, and referred to by the assignee of the present patent application as System C. System C preferably is operable on site processor 4, and provides many if not all of the databases, user interfaces and software controls required to perform the functionality described herein.

MP1, MP2, MP3, MP4, MP5 and MP6 personnel are preferably trained in the skills corresponding to their respective management platforms. By precluding parties from being responsible for matters in which they do not have the appropriate skill level, the present invention ensures efficiency and improves upon the ability for a custom home design and build project to reach a successful conclusion.

In accordance with the present invention, skills that are respective to a particular management platform (e.g., MP2) are taught and/or reinforced. For example and as described in detail below, computerized (e.g., “on-line”) training is made available to operators of System C which, in conjunction with operating System C, ensures that accurate and timely information is provided by the users. Further, a physical academy is provided which provides classroom and hands-on training both in the operations of System C and in the many tasks required to complete and custom home design and build project. As will become evident to one skilled in the art, as each of the features of System C are operated, training in the many aspects of custom home design and build projects is provided.

In one embodiment, management platform personnel 302-318 are employees of a proprietor of System C. Alternatively, some or all of management platform personnel 302-318 are independent contractors and not formal employees. Regardless of their formal employment status (employee versus contractor), however, each of the management platform personnel 302-318 preferably receive training in the many features of System C that are commensurate with their respective management platforms.

A brief discussion is now provided with regard to the respective MP platform personnel.

MP1 personnel 308 preferably focus on contacting and consulting individuals who own their own lots, or who may be seriously interested in a custom home design and build project. MP1 personnel 308 help potential home buyers 302 describe their dream homes and identify their personal financial situations that will support the design and build of the home. MP1 ensure that dreams of potential home buyers 302 are in alignment with their financial means.

In this way, a critical first step of the present invention is met by MP1 personnel 308 matching potential design and build customers 302 with consultants who qualify them as ready, willing and able to enter into the construction of custom home.

MP2 personnel 310 preferably comprise one or more members of a design team who meet with custom homebuyer 302 to begin process of designing preliminary sketches and specifications of a custom home design and build project, as well as to estimate costs associated therewith. MP2 personnel 310 preferably provide accurate estimates of costs associated with a custom home design and build project that is within one half to one percent of the final, actual cost of designing, engineering and constructing the home.

MP3 personnel 312 preferably coordinate builders 304, building details, vendors 306 and budgets associated with a new custom home design and build project. By coordinating these variables, prior art failures of custom homebuilders assuming responsibility for vendors 306 who do not otherwise have any initial input into a custom home design and build project are avoided. An advantage of the present invention over the prior art includes managing ongoing relationships with vendors 306. Vendors 306 must be approved and agree to perform within building expectations. Variables that are determined by MP2 personnel 310 during early stages of the custom home design and build project are coordinated before construction occurs. Further, MP3 personnel 312 preferably prepare a business plan that includes a fixed price budget, vendor 306 list and purchase orders.

In accordance with the present invention, buyers 302 work with designers, builders 304, estimators to determine final specifications of custom home design and build projects to ensure that all specifications meet building requirements. This is accomplished, in part, by requiring that custom homes are designed by parties to the present invention. MP3 personnel 312, accordingly, design and coordinate custom home design and build projects. Homebuyers 302, homebuilders 304 and vendors 306 all agree on every final detail prior to start of construction. This persistent focus is believed by the inventors to result in successful outcomes of custom home design and build projects that are completed on time and on budget.

MP4 personnel 314 manage cash flow of a custom home design and build project, thereby ensuring that delays, which often result dues to late payments and/or a project going over budget, are avoid. Preferably MP4 personnel 314 act as trustees for a project and monitor all financial transactions of a project and ensuring all vendors 306 are paid properly. Further, MP4 personnel 314 maintain financial transaction information in on-line databases provided by System C, thereby ensuring that up-to-date and accurate information regarding financial information is available at all times, for example, over the internet. By maintaining accurate information and demonstrating that vendors 306 are paid in a timely fashion, a healthy working relationship is ensured for all of the parties. Prior art problems, such as withholding money as a means to air grievances, is prevented.

MP5 personnel 316 manage the construction of a custom home design and build project. Preferably, parties are managed such that each custom home design and build project is built to specifications that exceed local building code requirements. Preferably, the builder 304 works with buyer 302 and meets formally on weekly basis to discuss progress and answer questions buyer 302 may have. This preferably occurs until the project is completed.

MP6 personnel 318 are preferably associated with closing, reconciliation, warranty, and final review of a custom home build and design project. MP6 personnel 318 preferably manage internal closing processes, and further manage customer 302 closing processes. Further, 30, 60 and 90 day post closing reviews are performed by MP6 personnel 318 to ensure that final items and tasks (e.g., set forth on a “punchlist”) are completed to specification and that any lingering or remaining questions posed by buyers 302 are answered. MP6 personnel 318 further perform internal audits of vendors 306 and materials to ensure that building expectations are met. Further, MP6 personnel 318 are responsible for inputting data into System C that represents a completed custom home design and build project. In this way, accuracy and usefulness of the system improves over time.

The present invention anticipates many hundreds of issues that unexpectedly arise in the prior art, and puts the parties to a custom home design and build project on notice of such issues. In this way, the negative emotional component that is experienced during a project is offset and the project is more enjoyable and successful as a result.

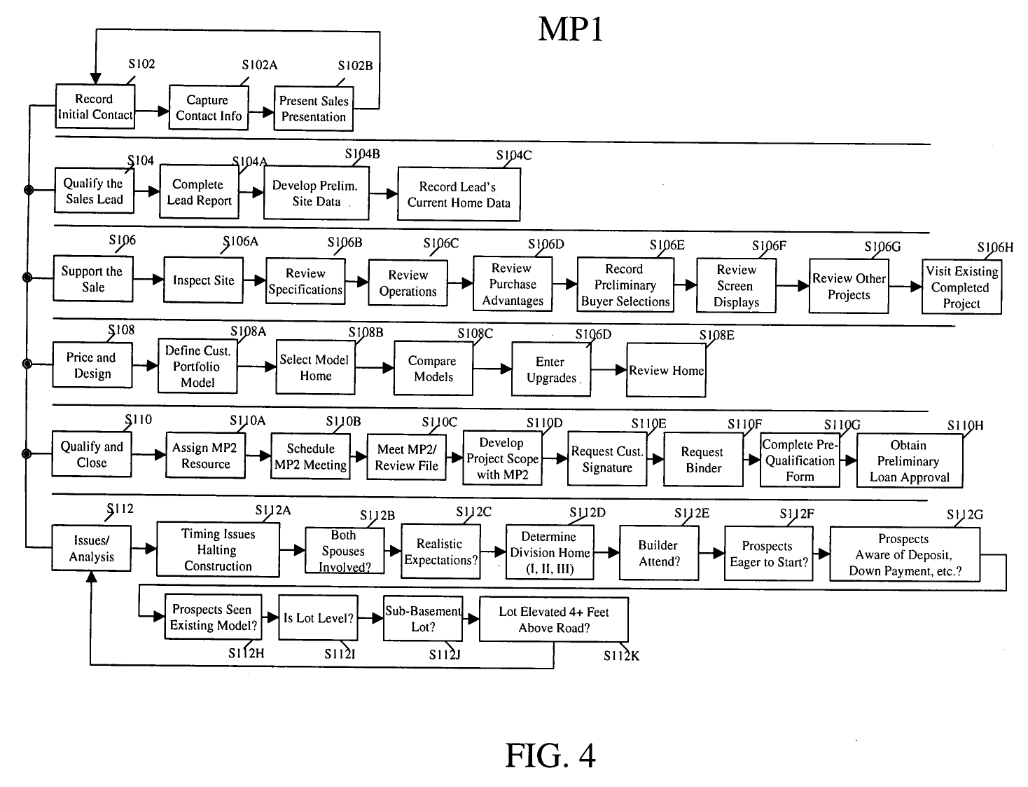

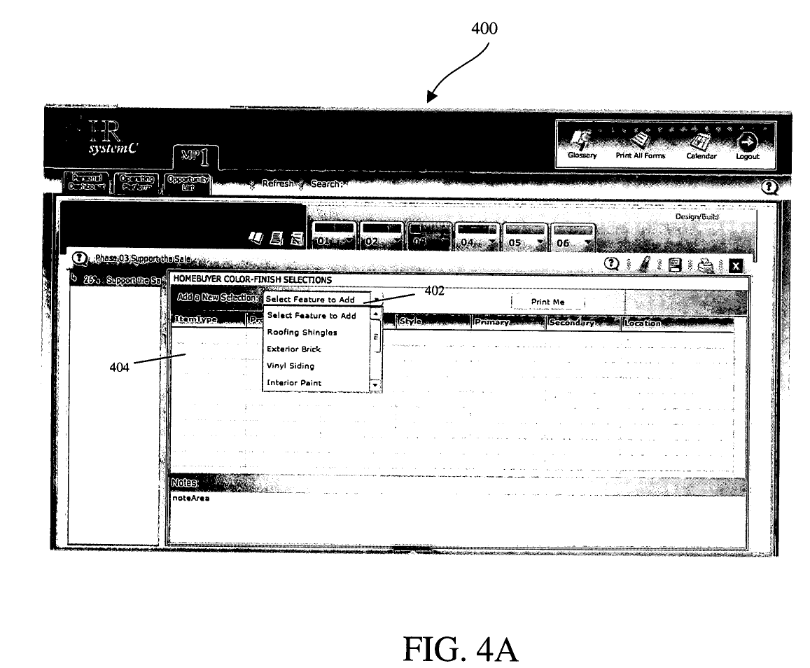

FIG. 4 is a flow chart illustrating steps associated with management platform 1 and preferably performed by MP1 personnel 308, including steps associated with initially establishing a relationship with a custom homebuyer 302, and nurturing that relationship to formalizing a contractual relationship that binds the parties to a custom home design and build project. At step S102, an introduction with custom homebuyer 302 contact is made and recorded by the MP1 personnel 308. For example, at step S102A, contact information is received and captured in System C, and a sales presentation is formally provided to the contact (S102B). At step S104, the preceding steps comprising S102 are designed to qualify a potential contact into a sales lead. A sales lead is considered herein, generally, as a potential custom home buyer 302 who is ready, willing and able to purchase a custom home design and build project. Preferably, a sales lead report is completed (step S104A), preliminary building site data is developed (step S104B), and data representing the sales lead's current home is submitted (step S104C).

Continuing with reference to FIG. 4, after a sales lead is defined, MP1 personnel 308 perform steps associated with supporting the sale of the custom home design and build project (step S106). Preferably, this includes steps associated providing information representing the sales lead's property, as well as informing the sales lead of various options and advantages provided by System C. For example, the sales lead's building site is inspected (step S106A), and site specifications are reviewed(step S106B). Moreover, operations associated with System C are reviewed with the sales lead (step S106C). Other features of System C are provided to the sales lead, including reviewing purchase advantages of the present invention (step S106D). Also during step S106E, preliminary buyer selections regarding the custom home design and build project are recorded, and screen displays are shown presenting standard house designs (step S106F). Further, the sales lead preferably reviews other custom home design and build projects (step S106G), and the sales lead preferably visits an existing and completed custom home design and build project (step S106H). This combination of steps S106A-H enables the sales lead to gain a clear understanding of the possibilities and advantages provided by System C, as well as to develop reasonable expectations associated with the sales lead's own custom home design and build project.

Continuing with reference to FIG. 4, at step S108, a sales lead is afforded an opportunity to begin designing plans associated with a custom home, as well as to review prices associated with designing and building a custom home. At step S108A, the sales lead is provided with a portfolio of model custom homes. Preferably, a custom home design model in selected (step S108B), which includes reviewing and comparing respective models of custom home designs (step S108C). After a particular model custom home is selected, the sales lead identifies various upgrades that are desired, and the upgrades are submitted into System C (step S108D). Thereafter, the custom home, including the various upgrades, is reviewed (step S108E). A electronic file is developed from the data selected or provided to this point, and the file used to continue the custom home design and build project.

During the preceding steps, the contact preferably evolves into a sales prospect, and is established during the preceding steps to be ready, willing and able, and more likely than not to purchase a custom home design and build project. A prospect preferably has a lot under contract or owns a lot, considers the system and methods described herein as a viable choice, has realistic expectations, has financial means to complete a project, and understands the cost structures of the many portfolio homes illustrated in System C.

After the contact has evolved into a prospect, the prospect is formally evaluated in order to qualify and eventually to close on the custom home design and build project (step S110). At step S110A, for example, MP2 personnel 310 is assigned, and a meeting is scheduled with the MP2 personnel 310 (step S110B). During the meeting, the electronic file previously developed is reviewed by the MP2 personnel 310 (step S110C), and the scope of the custom home design and build project is developed (step S110D). Thereafter, the prospect is requested to provide a signature (step S110E) and a binder is requested (step S110F) that enables a custom home design and build project pre-qualification form to be completed (step S110G). Once completed, preliminary loan approval for the custom home design and build project is obtained (step S110H).

Continuing with reference to FIG. 4, after the prospect is formally evaluated in order to qualify and eventually to close, then at step S112, potential issues that may impede the custom home build and design project are identified and analyzed. For example, timing issues are identified that may halt construction (step S112A). Further, the MP1 personnel 308 identify whether, in case a homebuyer 302 is married, both spouses were present up to this point in the process (step S112B). It is believed by the inventors that a custom home design and build project is highly likely to fail if one spouse is absent or not participating in major decisions associated with the project. Other issues that require identification by MP1 personnel 308 include whether the prospect has realistic expectations (S112C), the size and quality of the custom home (e.g., a division I, II or III structure) (step S112D), whether the custom builder has attended any meetings to date (step S112E), whether the prospect is eager to start construction (step S112F), whether the prospect is aware of financial responsibilities, including any initial down payment that may be required (step S112G), whether the prospect has physically seen an existing model (step S112H), whether the prospect's building lot is level (step S121I), whether the prospect's building lot is a sub-basement lot (step S112J), and whether the prospect's lot is elevated at least four feet above the road the lot is on (step S112K). By identifying and addressing these issues during the MP1 stages, the present invention ensures efficiency and prevents parties and resources from being wasted.

FIG. 4A is an example display screen 400 that illustrates a data entry form used for submitting information corresponding to MP1 tasks. In the example shown in display screen 400, MP1 personnel 308 are performing steps associated with supporting a sale, and are submitting information representing a buyer's preliminary selections, corresponding with step S106E (FIG. 4). In dropdown list control 402, the user makes a selection, such as roof shingles, exterior brick, vinyl siding, interior paint or the like. Thereafter, the selections are recorded in System C and displayed, for example, in table 404.

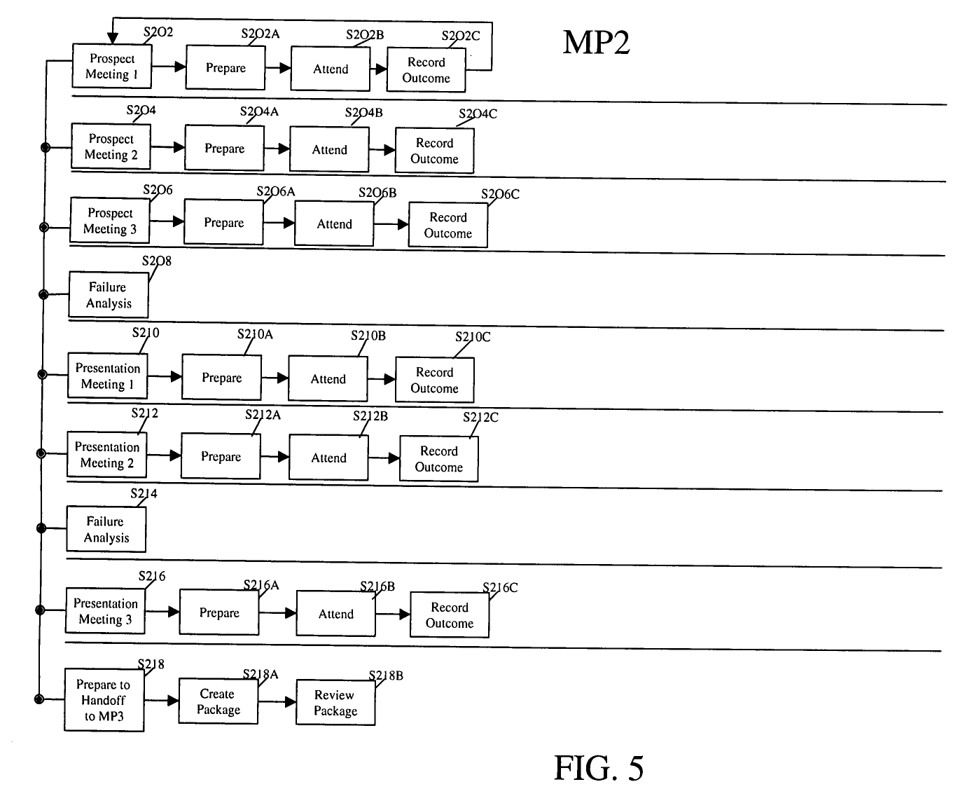

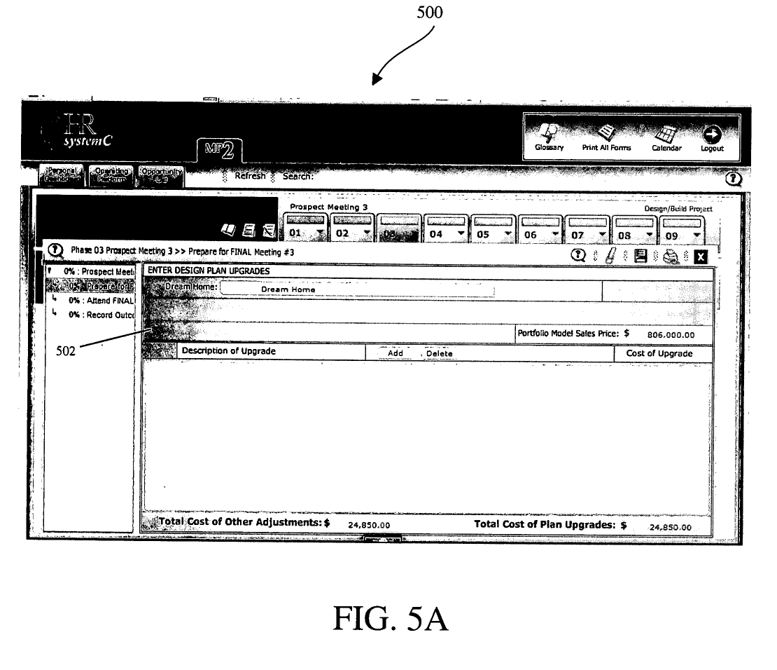

FIG. 5 is a flow chart illustrating steps associated with management platform 2, including steps associated with a custom home design team meeting with the prospect. As noted above, during MP2 steps, preliminary sketches are produced, specifications are identified and developed, and cost is determined. Preferably, up to three prospect meetings are attended as needed (steps S202-S206), wherein personnel prepare, attend and record outcomes thereof (steps S202A-C, S204A-C and S206A-C, respectively). During preparation, MP2 personnel 310 preferably review a prospect's rating (e.g., a value representing the likelihood that a prospect will complete a custom home design and build project, including how the prospect was introduced, whether the prospect owns a lot, the financial means of the prospect and other variables that are implemented in an algorithm to provide a sophisticated ranking of prospects and serving to predict the likelihood of success). Other activities include reviewing portfolio model and project parameters, a control model, plan upgrades, preliminary plot plans, a scaled floor plan and elevation sketch, and create and price added design options. During the meetings, prospect and the design team review advantages of System C, as well as all design/specification materials, and further develop sketches. Further, a price is preferably quoted with site allowances, parameters are converted to project scope with details, and the contract and any price guarantee (e.g., a forty-five day guarantee) are explained to the prospect, and a sale/deposit is requested. If necessary, another prospect meeting is scheduled. After the meeting is concluded, personnel preferably record the outcome by submitting data in data entry display forms. For example, the geography of the building site, the number of bedrooms, the number of storys, location of master bedroom, specification level, number of full/half bathrooms, respective floor ceiling heights are recorded, siding materials, and the like are submitted to generate a control model sales price.

Continuing with reference to FIG. 5, after up to three meetings are completed, an analysis of any failure in the process is performed (step S208). For example, particular failure points are identified and lessons learned from the failure points are further entered into System C. In case the failures, if any, are not insurmountable, then the process continues to steps S210-S214 wherein up to three presentation meetings (as needed) are prepared for (steps S210A, S212A and S216A), attended (steps S210B, S212B and S216B), and outcomes thereof are recorded (steps S210C, S212C and S216C). For example, during preparation, a control model plan is reviewed, a physical site inspection report is reviewed, a plan price is revised (if necessary) and plans per project scope are prepared. During attendance of the presentation meetings, the plans are reviewed, signatures are requested deposits are requested and, if necessary, follow up presentation meetings are arranged. Once again, a failure analysis (step S214) is performed to identify and analyze any failures occurring before, during or after a presentation meeting. Upon conclusion of the final presentation meeting, the project is prepared for handoff to MP3 personnel 312 (step S218). This occurs, for example, by creating and reviewing a file package (steps S218A and S218B).

FIG. 5A is an example display screen 500 that illustrates a data entry form used for submitting information corresponding to MP2 tasks. In the example shown in display screen 500, MP2 personnel 310 are performing steps associated with preparing for preparing for a third prospect meeting, corresponding with step S206A (FIG. 5). In the example shown in FIG. 5A, plan upgrades are being reviewed in plan upgrades display area 502.

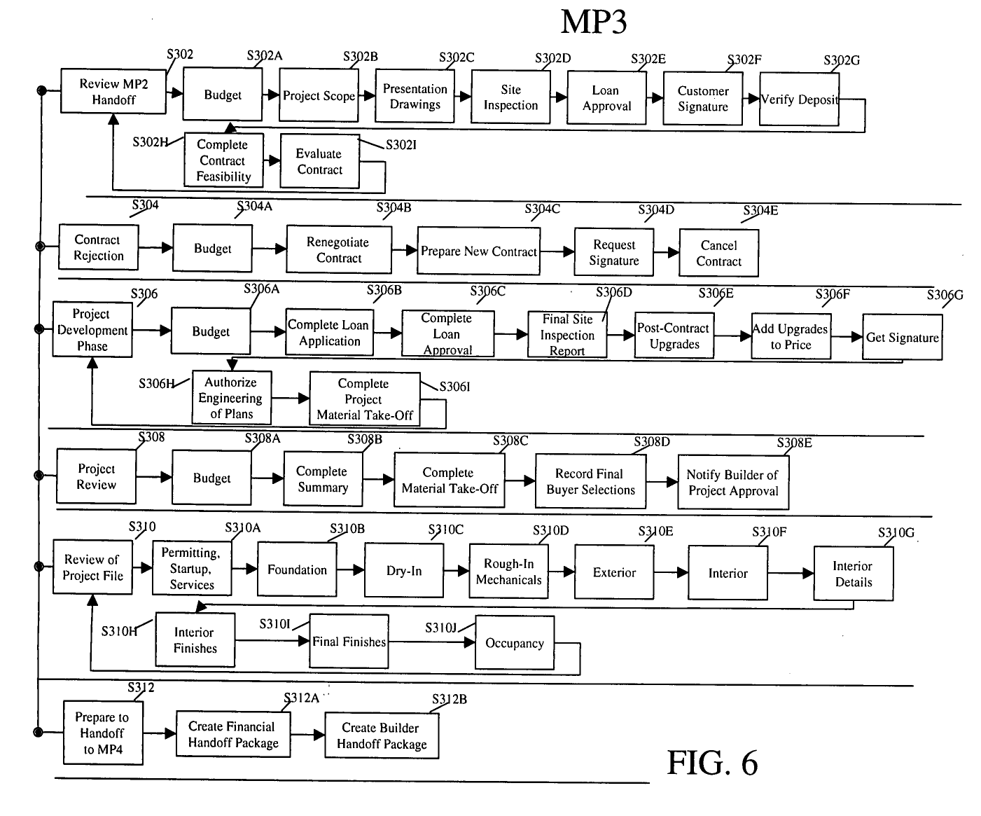

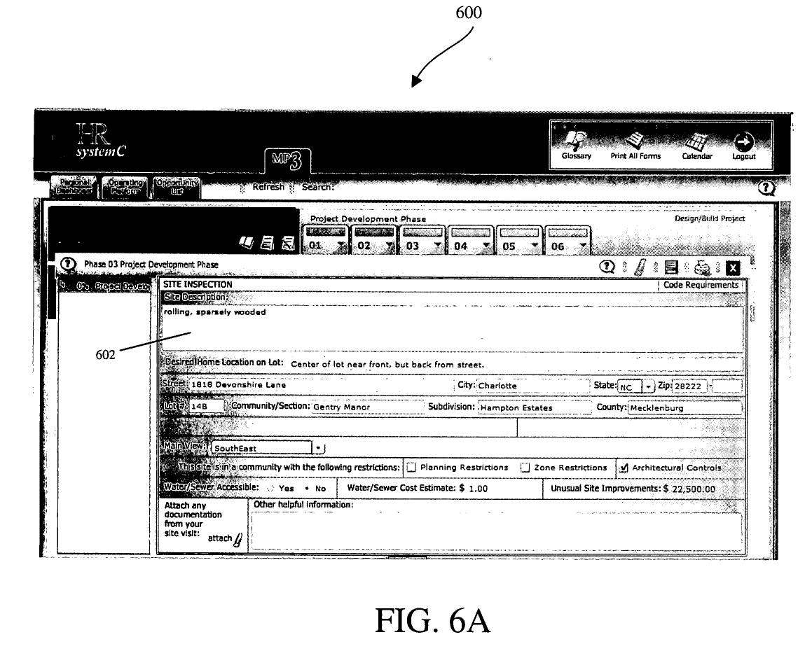

FIG. 6 is a flow chart illustrating steps associated with management platform 3, including steps associated coordinating building details, building vendors 306 and operating budget. At step S302, a review of the handoff from the MP2 personnel 310 is performed, including reviewing the budget (step S302A), the project scope (step S302B), presentation drawings (step S302C), site inspection (step S302D), loan approval (step S302E), customer signature (step S302F), deposit verification (step S302G). Further contract feasibility is completed (step S302H), and the contract is evaluated (step S302I). These steps ensure that steps preceding MP3-related tasks are completed accurately, and serve to increase efficiency by preventing additional steps from taking place if any preceding step required for successful completion of a custom home design and build project are complete.

Continuing with reference to FIG. 6, it is possible that performing the steps associated with step S302 will result in a contract being rejected (step S304). In such case, the budget is reevaluated (step S304A), a contract is renegotiated (step S304B), a new contract is prepared (step S304C), a signature is requested (step S304D) and the previous contract canceled (step S304E). Continuing with the process, a detailed project development phase occurs (step S306) in which variables that were previously determined during steps associated with MP2 are coordinated before construction begins. The steps associated with the project development lead MP3 personnel 312 to prepare an accurate business plan, including a fixed price budget, vendor 306 list and purchase orders required for construction of the custom home design and build project. Particularly, the budget is reviewed and adjusted as necessary (step S306A), a buyer loan application is completed (step S306B) and approved (step S306C). Further, a final site inspection report is generated (step S306D) and any post-contract upgrades are identified (step S306E). The upgrades are preferably added to the price of the project (step S306F) and the prospect's signature is obtained therefor (step S306G). Once the signature is obtained, the engineering of plans is authorized (step S306H) and the project material take-off authorization is provided (step S306I). In this way, prospects work with designers, builders 304, estimators to determine final specifications of custom home design and build project.

Following step S306, a project review is preferably performed (step S308). In particular, the budget is reviewed (step S308A), a summary report is completed (step S308B), a material take-off is completed (step S308C), final selections of the prospect are recorded (step S308D) and builder 304 is preferably notified that the project is approved (step S308E). Thereafter, the project file is preferably reviewed by the builder 304 (step S310). Preferably, steps associated with step S310 include work associated with permits, startup work and services (step S310A), preparing the foundation (step S310B), dry-in (step S310C), rough-in mechanicals (step S310D), exterior (step S310E), interior (step S310F), interior details (step S310G), interior finishes (step S310H), final finishes (step S310I) and occupancy (step S310J). Once the steps associated with step S310 are complete, the project is prepared for handoff to MP4 personnel 314 (step S312). This includes creating a financial handoff package (step S312A) and a builder handoff package (step S312B).

FIG. 6A is an example display screen 600 that illustrates a data entry form used for submitting information corresponding to MP3 tasks. In the example shown in display screen 600, MP3 personnel 312 are performing tasks associated with S306D (FIG. 6), and are reviewing and preparing a final site inspection report. Site inspection report section 602 includes information regarding the prospect's site.

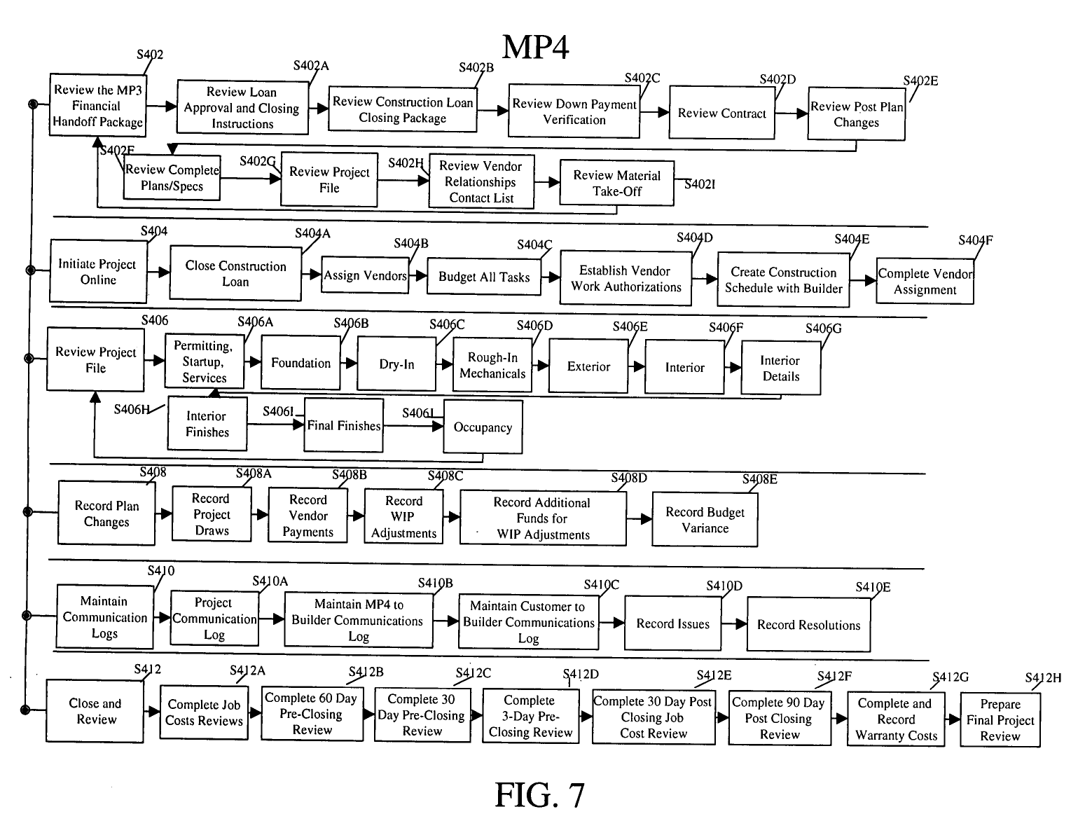

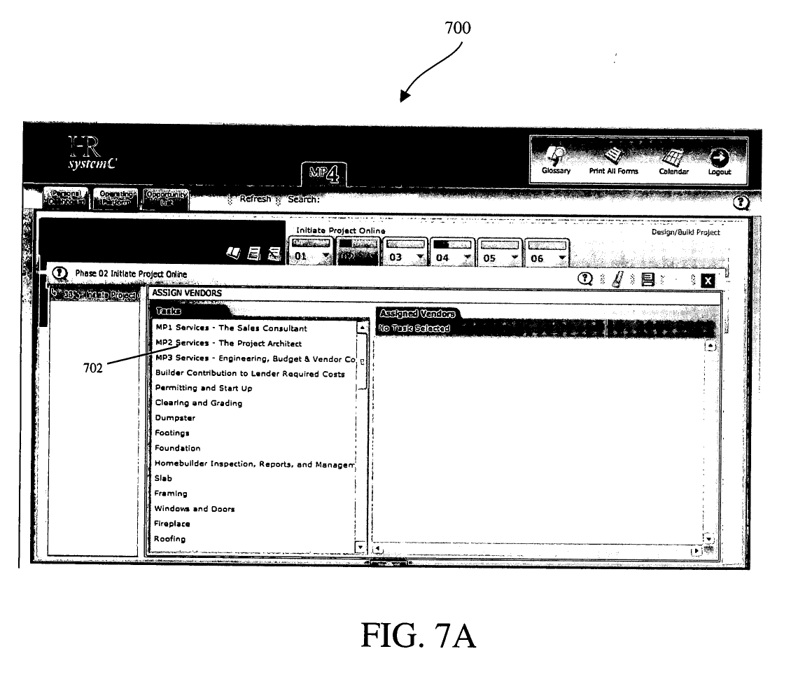

As noted above, tasks associated with management platform 4 are directed principally to financial activities. FIG. 7 is a flow chart illustrating steps associated with managing the cash flow of a custom home design and build project. At step S402, a review of the handoff from the MP3 personnel 312 is performed, including reviewing loan approval and closing instructions (step S402A), reviewing construction loan closing package (step S402B), reviewing down payment verification (step S402C), reviewing the contract (step S402D), reviewing post plan changes (step S402E), reviewing complete plans/specifications (step S402F), reviewing a project file (step S402G), reviewing vendor 306 relationships contact lists (step S402H) and reviewing material take-off (step S402D. These steps ensure that steps preceding MP4-related tasks are completed accurately, and serve to increase efficiency by preventing additional steps from taking place if any preceding step required for successful completion of a custom home design and build project are complete.

Continuing with reference to FIG. 7, management of cash flow and financing occur during MP4, and include initiating the project to be available over a communication network, such as the intemet, particular with respect to financial requirements (step S404). For example, at step S404A, a construction loan for the project is closed. Further, vendors 306 are assigned (step S404B), tasks are budgeted (step S404C), vendor 306 work is authorized (step S404D), a construction schedule with a builder is created (step S404E) and remaining vendor 306 assignments are completed (step S404F).

After the project is initiated on-line (step S404), the project file is reviewed (step S406). Preferably, steps associated with step S406 include steps associated with work associated with permits, startup work and services (step S406A), preparing the foundation (step S406B), dry-in (step S406C), rough-in mechanicals (step S406D), exterior (step S406E), interior (step S406F), interior details (step S406G), interior finishes (step S406H), final finishes (step S406I) and occupancy (step S406J). Thereafter, plan changes are submitted (step S408). Steps associated therewith include recording project draws (step S408A), recording vendor 306 payments (step S408B), recording work-in-process (“WIP”) adjustments(step S408C), recording additional funds for WIP adjustments (step S408D) and recording any budget variance (step S408E).

Further, MP4 maintain communication logs (step S410). For example, a project communication log is maintained (step S41OA), an MP4 personnel 314 to builder communications log is maintained (step S410B), a customer to builder communications log is maintained (step S410C), issues are recorded (step S410D) and resolutions to issues are recorded (step S410E). Such communication logs are very useful for avoiding misunderstandings and to ensure that parties are aware of the development, progress and potential issues associated with a custom home design and build project.

After steps S402-S410 are complete, the MP4 personnel 314 preferably close and review the project (step S412). This includes, for example, reviewing job costs (step S412A), completing a 60 day pre-closing review (step S412B), completing a 30 day pre-closing review (step S412C), completing a 3 day pre-closing review (step S412D), completing a 30 day post-closing review (step S412E), completing a 90 day post-closing review (step S412F), completing and recording warranty costs (step S412G) and preparing a final project review (step S412H).

FIG. 7A is an example display screen 700 that illustrates a data entry form used for submitting information corresponding to MP4 tasks. In the example shown in display screen 700, MP4 personnel 314 are assigning vendors to respective tasks, such as corresponding with step S404B (FIG. 7). Vendor task assignment section 702 enables the user to select a respective task, such as clearing and grating, and then assign a vendor for the respective task.

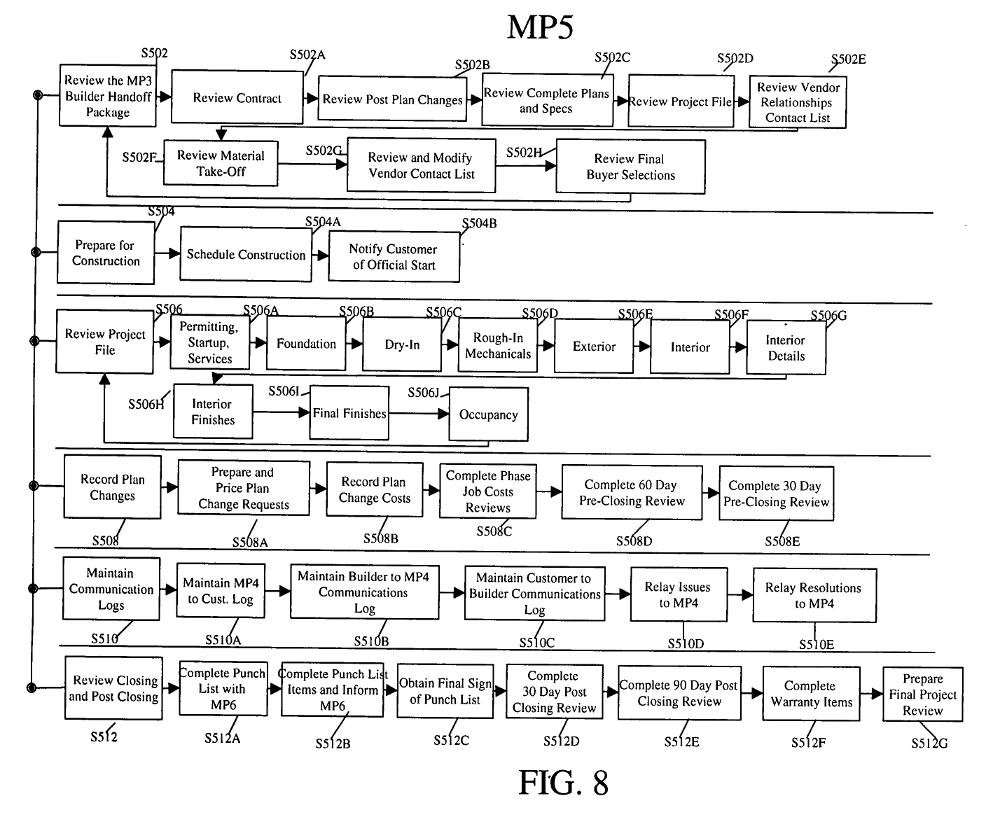

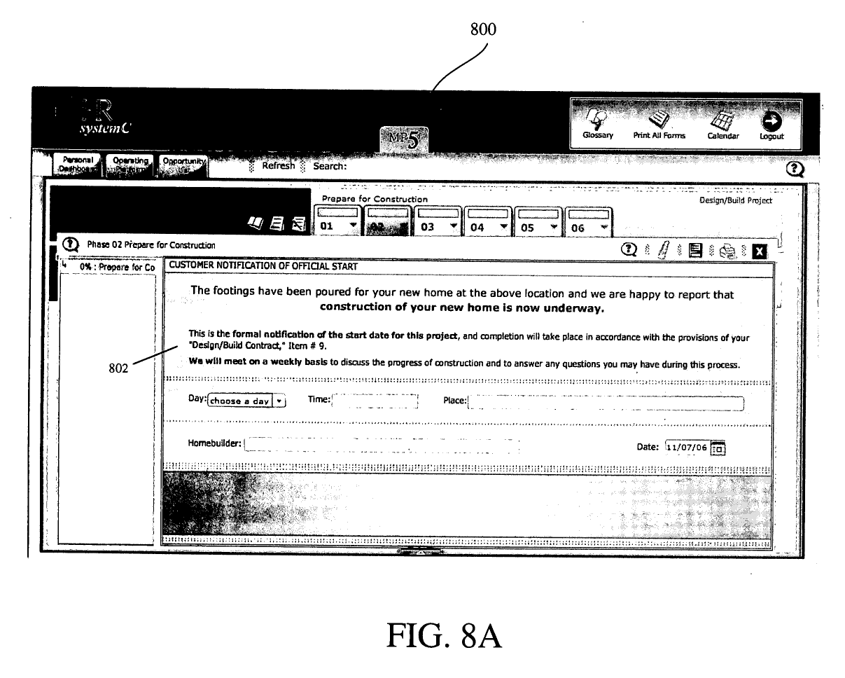

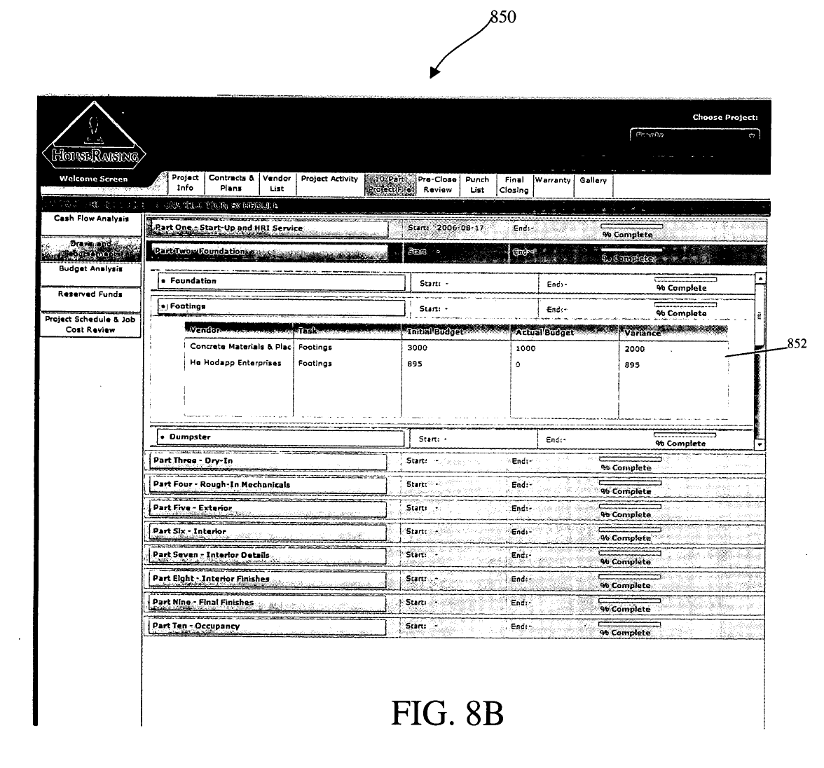

As noted above, tasks associated with management platform 5 are directed principally to the physical construction and building of the custom home design and build project. FIG. 8 is a flow chart illustrating steps associated with managing the building process associated with a custom home design and build project. Similar to that as described above with reference to step S402 (FIG. 7), steps are performed for reviewing the MP3 builder handoff package (step S502). Particularly, the contract is reviewed (step S502A), post plan changes are reviewed (step S502B), complete plans and specifications are reviewed (step S502C), the project file is reviewed (step S502D) and the vendor 306 relationships contact list is reviewed (step S502E). Further, the material take-off is reviewed (step S502F), the vendor 306 contact list is reviewed and modified, if necessary, (step S502G) and the buyer's 302 final selections are further reviewed (step S502H).

Continuing with reference to FIG. 8, at step S504, MP5 personnel 316 prepare for construction by schedule construction with builders 304 (step S504A) and notifying the homebuyer 302 of an official start (step S504B). At step S506, the project file is reviewed and implemented. Preferably, steps associated with step S506 include steps associated with work associated with permits, startup work and services (step S506A), preparing the foundation (step S506B), dry-in (step S506C), rough-in mechanicals (step S506D), exterior (step S506E), interior (step S506F), interior details (step S506G), interior finishes (step S506H), final finishes (step S506I) and occupancy (step S506J).

Thereafter, plan changes are submitted (step S508). Steps associated therewith include preparing and determine a price for plan change requests (step S508A), submitting plan change costs (step S508B), reviewing complete phase job costs (step S508C), completing a 60 day pre-closing review (step S508D) and completing a 30 day pre-closing review (step S508E).

As described above with reference to MP4 personnel 314 (FIG. 7), MP5 personnel 316 are similarly charged with maintaining communication logs (step S510). For example, MP5 personnel 316 maintain an MP4 to customer log (step S510A), maintain a builder to MP4 communications log (step S510B), maintain a customer to builder communications log (step S510C), relay issues encountered during MP5 tasks to MP4 personnel 314 (step S510D), and further relay resolutions to those issues to MP4 personnel 314 (step S510E). In this way, communication pathways are maintained and visible to a plurality of parties who require regular and timely information regarding a custom home design and build project.

Further (and with continued reference to FIG. 8), MP5 personnel 316 are charged with reviewing the closing and post closing of a custom home design and build project to ensure a successful completion (step S512). Preferably, a “punch list” identifies items or labor that require completion or resolution even though the new construction is ready for occupancy. At step S512A, the punch list is completed with work from MP6 personnel 318. Further, the items in the punch list are preferably completed by MP5 personnel 316, and MP6 personnel 318 are preferably informed by the MP5 personnel 316 (step S512B). Further, MP5 personnel 316 obtain a final sign off of the punch list by the buyer 302 (step S512C), complete a 30 day post-closing review (step S512D), complete a 90 day post-closing review (step S512D) and complete warranty items (step S512E). Thereafter, MP5 personnel prepare a final project review (S512F).

FIG. 8A is an example display screen 800 that illustrates a data entry form used for submitting information corresponding to MP5 tasks. In the example shown in display screen 800, MP5 personnel 316 are notifying a buyer 302 of the official start of construction, corresponding with step S504B (FIG. 8). Notification section 802 enables the user to select a day, time and place for start of construction, as well as to notify the buyer of the construction start.

A particularly useful feature of the present invention is the ability for interested parties to review the status of a custom home design and build project. FIG. 8B illustrates an example display screen 850 that provides graphical screen controls and displays for a party to monitor a custom home design and build project. As shown in FIG. 8B, vendors 306 who provide footings are listed in section 852, as well an identification of budget variances (plus or minus) that have occurred during construction. As indicated in display screen 850, a summary review of each of the ten phases of a custom home design and build project (as described in greater detail in the '569 patent application) is provided.

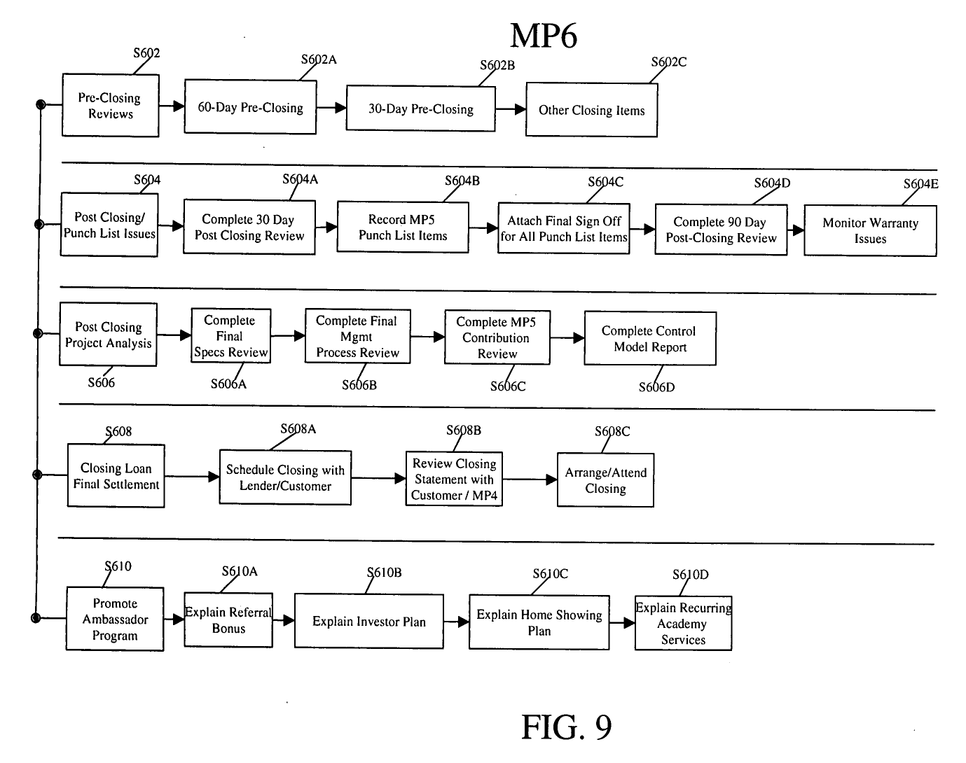

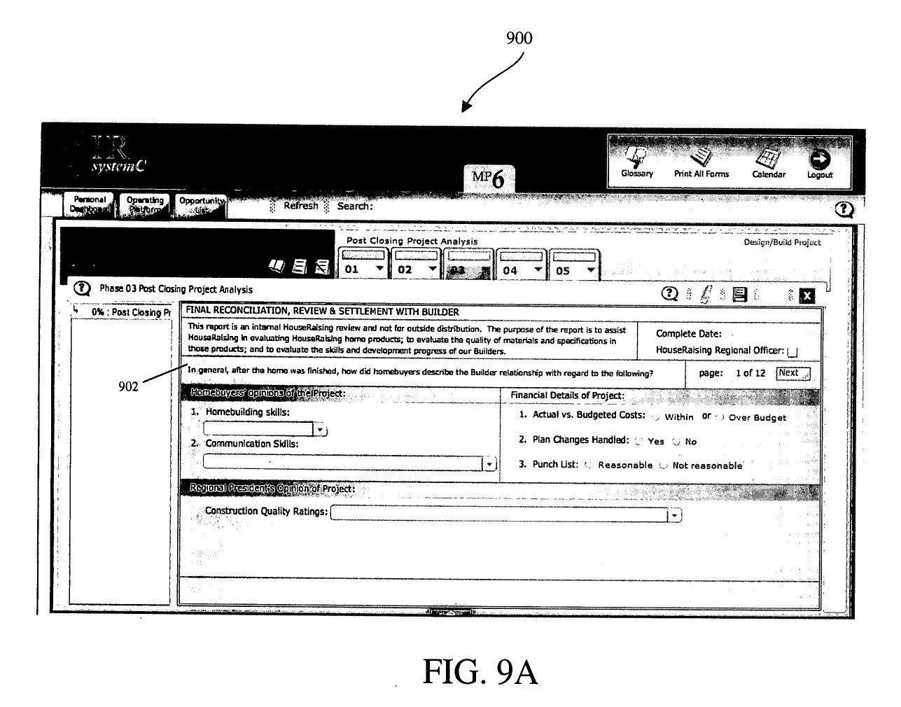

FIG. 9 is a flow chart that illustrates steps associated with completion of a custom home design and build project. At step S602, pre-closing reviews are performed. For example, a 60 day pre-closing review is performed (step S602A), a 30 day pre-closing review is performed (step S602B), and other closing items are reviewed (step S602C). Further, at step S604, post-closing and punch list issues are reviewed. For example, a 30 day post-closing review is performed (step S604A), punch list items to be performed by MP5 personnel 316 are submitted (step S604B), a final sign-off for all punch list items is attached (step S604C), a 90 day post-closing review is performed (step S604D) and warranty issues are monitored (step S604E).

At step S606, MP6 personnel 318 perform post closing project analysis, for example, by completing a final specifications review (step S606A), completing a final management process review (step S606B), completing an MP5 contribution review (step S606C), and completing a control model report (step S606D). MP6 personnel 318 are further preferably responsible for a closing loan final settlement (step S608). In particular, this includes scheduling a closing with the lender and the homebuyer 302 (step S608A), reviewing a closing statement with the customer and MP4 personnel 314 (step S608B), and arranging and attending the final closing (step S608C).

After the final closing, MP6 personnel 318 further support promotional programs that may be offered by a proprietor of the present invention (step S610). For example, MP6 personnel 318 promote referral bonuses that a custom homebuyer 302 may be entitled to (step S610A). Further, MP6 personnel explains to the homebuyer 302 an investor plan in the system described in the '569 patent application and in a franchise or other investment in the system and method described herein (step S610B). Other promotions that may be encouraged by MP6 personnel 318 include a home showing plan (step S610C) in which the homebuyer 302 agrees to allow the custom home to be shown to other contacts and/or prospects. Further, MP6 personnel 318 further promote recurring academy services in accordance with the present invention (step S610D). Academy services may include, for example, continued and recurring support and services provided for homebuyers 302. For example, home security, home automation services and other home services are envisioned herein. Moreover, home utilities and various services, such as landscaping services, may be provided by the present invention. Virtually any ongoing services or needs required by homebuyers 302 may be provided by the proprietor of the present invention. In this way, the relationship between the buyers and providers does not end at closing, but can last for generations.

FIG. 9A is an example display screen 900 that illustrates a data entry form used for submitting information corresponding to MP6 tasks. In the example shown in display screen 900, MP6 personnel 318 are preparing a final control model report, corresponding with step S606D (FIG. 9). The user preferably uses control model section 902 to submit information regarding the homebuilder's 304 skills, the quality of the construction, or the like.

Thus, using the respective management platforms, data entry forms for monitoring tasks, parties and details of a custom home design and build project, the present invention assures the likelihood that a project will be completed on time, on budget and to the great satisfaction of all parties involved.

As noted above, the present invention provides training and educational services in virtually every aspect described herein. In one context, training is provided to a user of System C in real time and in various ways. Training and information is preferably provided in textual format, in an audio format, or in a multi-media format. Examples are described below.

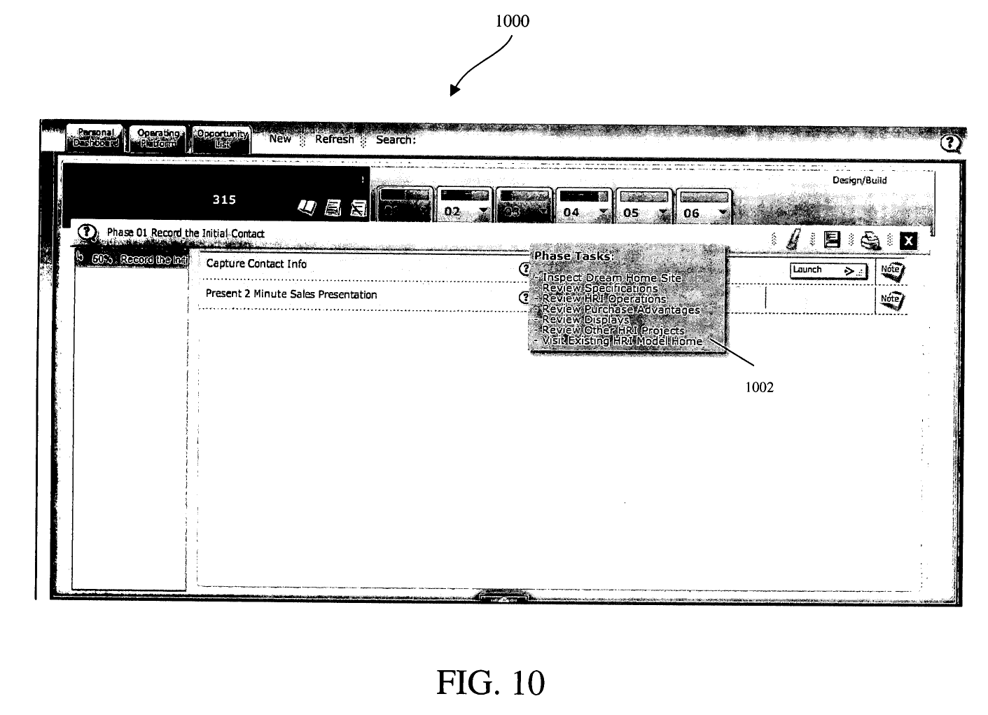

One way in which training is provided in an on-line environment is via displayed information that appears when a user places his selector (e.g., mouse or other device) over a particular control. FIG. 10 illustrates an example display screen 1000 that illustrates a tool tip 1002 being displayed. Tool tips 1002 are useful to locate information quickly and easily, and provide context-sensitive information literally on the fly.

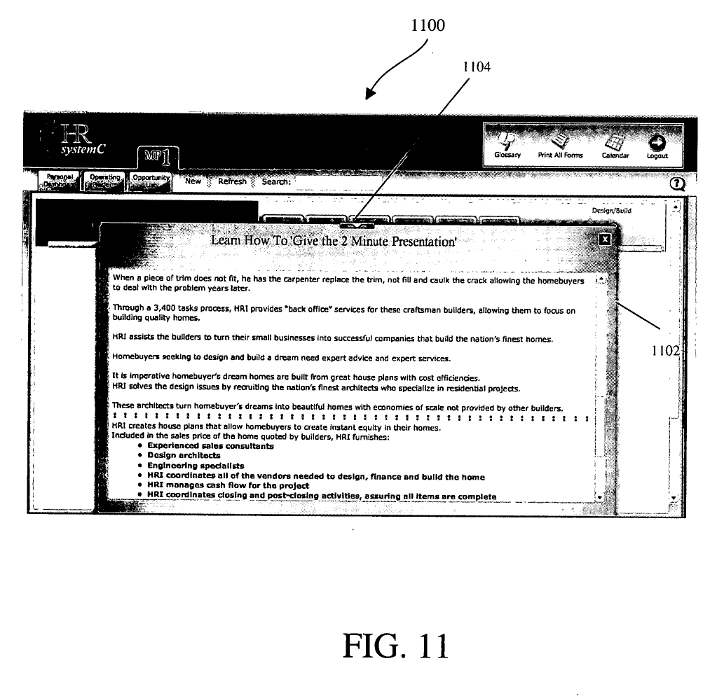

FIG. 11 illustrates an example on-line training screen 1100 that provides general training for MP1 personnel 308 in giving a two-minute presentation. As illustrated in FIG. 11, embedded display screen 1102 appears in response to a control being selected by the user, and can be read at will. When the user is finished reading the training information, (s)he selects control 1104 which causes the embedded display screen to disappear. In this way, general training information is provided to users regarding topics associated with the various management platforms and associated with a custom home design and build project in accordance with the present invention.

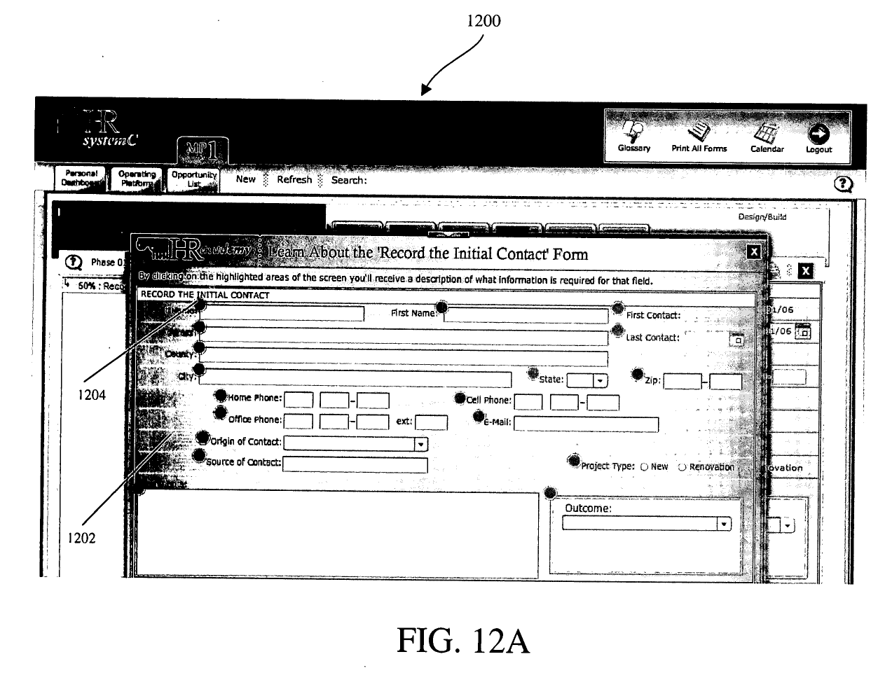

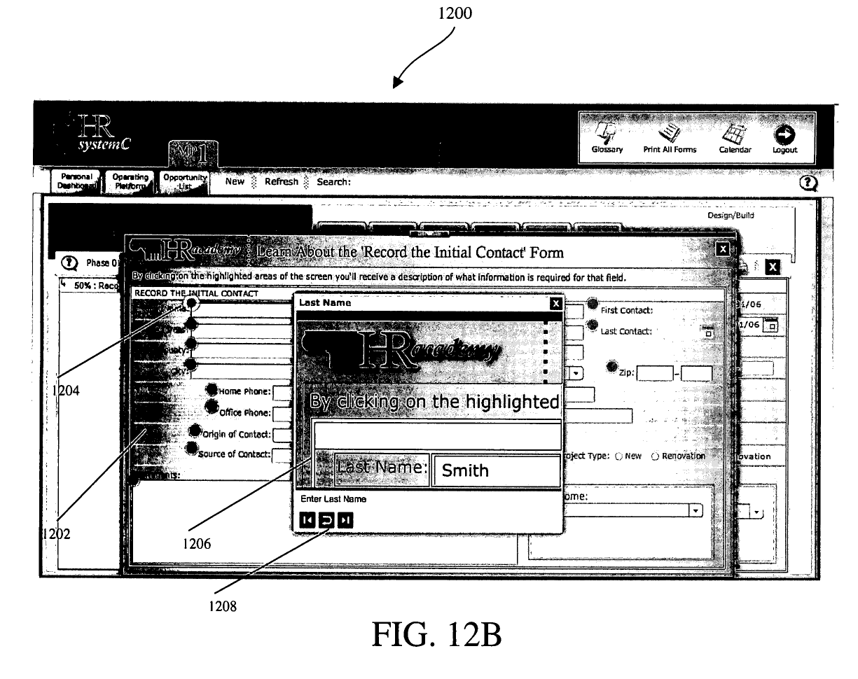

FIGS. 12A and 12B illustrate contextual training that is provided by the present invention, and further illustrate the level of granularity the present invention provides in terms of training and support that far exceeds any custom homebuilding automated system in the prior art. As shown in FIGS. 12A and 12B, display screen 1200 is provided for MP 1 personnel 308 to submit information corresponding to S102 (FIG. 4). The training element of the present invention displays embedded display screen 1202 that represents the data entry form in a particular context. As shown in FIG. 12A, each of the data entry elements (e.g., data entry “fields”) for an initial contact form and that require the user to submit information are displayed and identified via markers 1204. The user can preferably receiving training in any of the elements by selecting a respective marker 1204. Thereafter, as shown in FIG. 12B, multimedia display screen 1206 is preferably presented and provides the user with a multimedia presentation directed to the respective element represented by the selected marker 1204. The user can, via control 1208, rewind, replay or fast-forward the multi-media display to receive custom and continual training in the respective field.

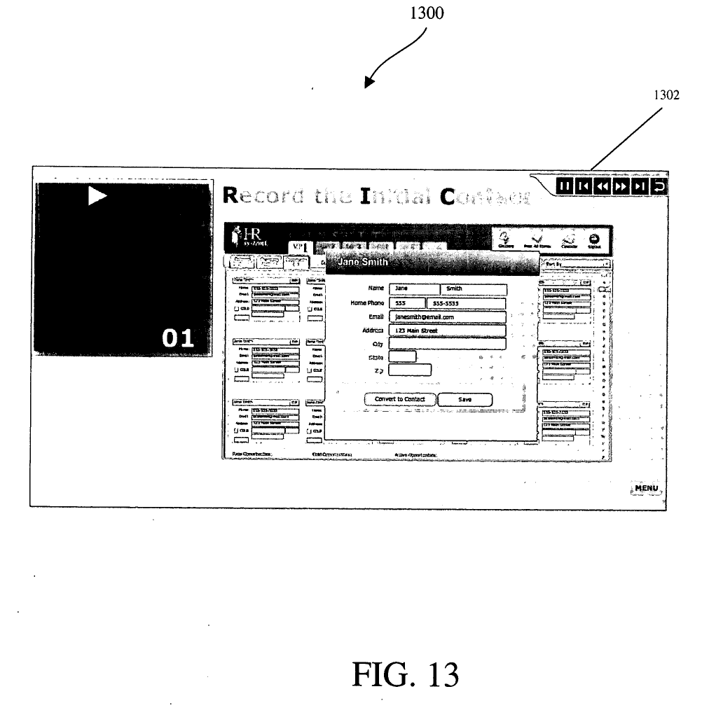

FIG. 13 illustrates an example display screen 1300 showing a multi-media presentation provided in accordance with a preferred embodiment for MP1 personnel 308 to enter contact information. The example shown in FIG. 13 represents training that is formatted to represent steps associated with accurate and timely data entry. Moving image controller 1302 preferably enables a user to pause, rewind, fast-forward, loop and play the training segment for custom use.

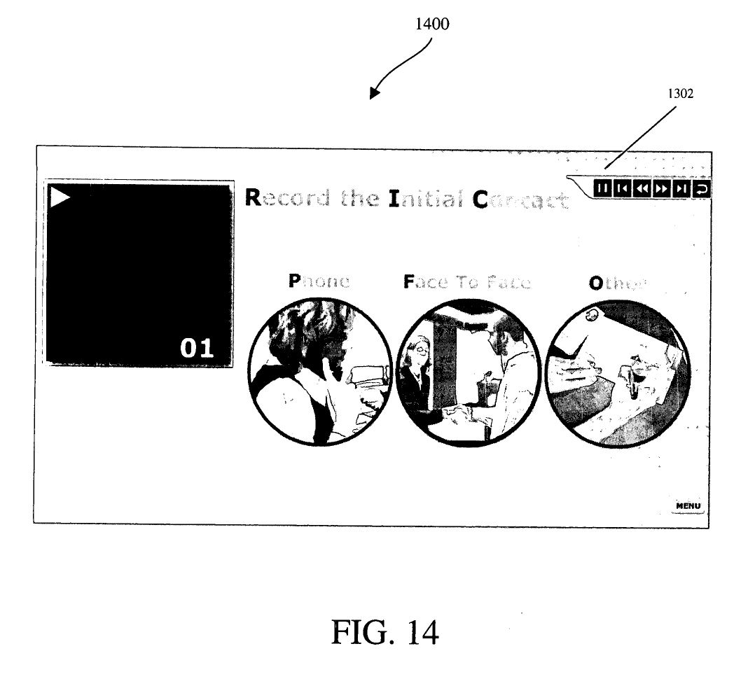

FIG. 14 illustrates an example display screen 1400 that presents a multi-media presentation for training MP1 personnel 308 how to record an initial contact. Beyond the steps associated with entering data in System C, example display screen 1400 illustrates training of the present invention for MP1 personnel 308 in proper ways to communicate with contacts, for example, proper ways to conduct oneself, as well as how to maximize the potential of any particular contact.

Thus, as illustrated in the example display screens shown in FIGS. 10-14, users of System C are preferably afforded training at each and every level of detail associated with a custom home design and build project. Although the examples shown in FIGS. 10-14 are directed to MP1 personnel 308, one skilled in the art will recognize that each and every element provided by System C preferably has a training feature associated therewith that can comprise text, audio and/or audio-visual components.

Although training is afforded in accordance with the present invention in an on-line computer provided context, the invention is not so limited. In a preferred embodiment, a physical academy is included that provides training for users of the present invention. For example, classrooms are provided that include computer work stations that enable builders 304 and/or vendors 306 to be trained in the many methods and systems defined herein. For example, training is provided for successfully operating a proprietary design/price module that electronically unique homes thereby preventing home buyers 302 from prematurely investing in house plans. The trainees of the design/price module learn to assist homebuyers and builders 304 to create and price homes within minutes, and further to reduce anxieties typically caused by paying for house plants that do not meet the financial needs of a participant. The price/design module predicts costs of unique home projects to within a half to one percent of an actual cost.

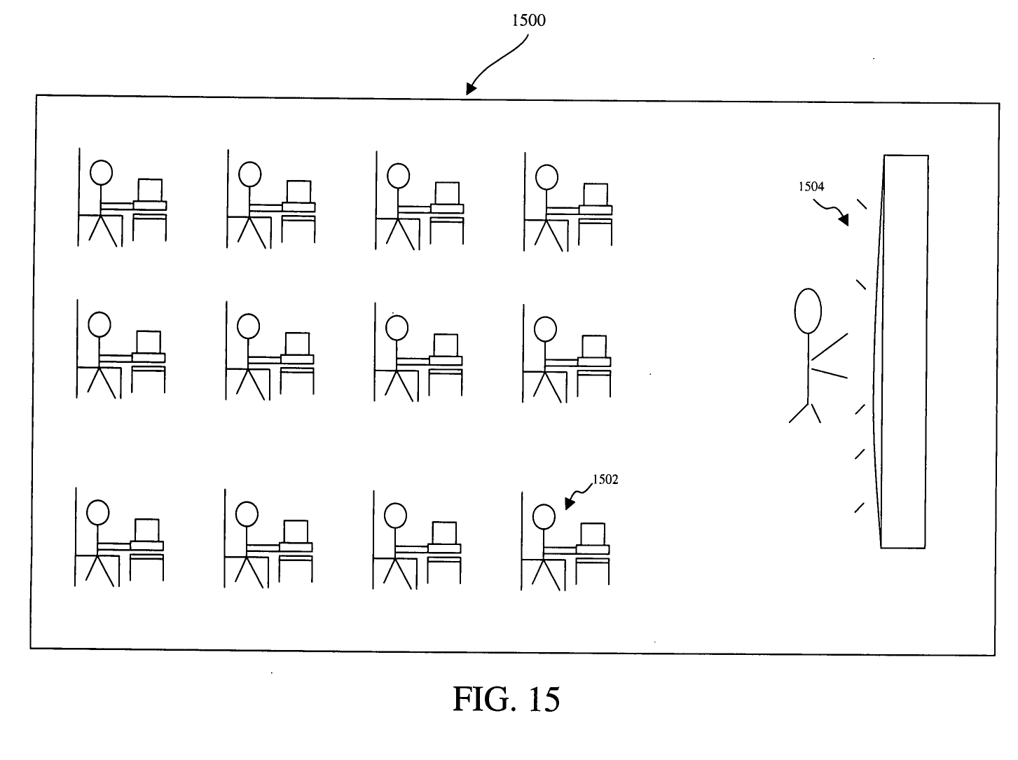

FIG. 15 illustrates an example classroom 1500 provided in accordance with the present invention wherein trainees receive didactic training while seated at computer workstations 1502. Simultaneously, an instructor preferably teaches from monitor 1504 that operates in connection with (or independently of) the workstations 1502. In this way, management platform personnel 302-318, buyers 302, builders 304 and vendors 306 are provided classroom training in the systems and methods described herein.

Preferably, various kinds of seminars are provided in classroom 1500. For example, homebuilders 304 are trained to build pre-sold homes and to supply the buyer 302 with support and back office services. Seminars are provided as working resources in the training of certain policies, procedures and how-to, check-sheet information involving every critical area of the homebuilding industry. In addition to successes, students are preferably taught of mistakes and first hand experiences shared by builders and vendors in all of the issues identified in a custom home design and build project.

The following are some example seminars that may be taught in classroom 1500.

One seminar may represent an overview of the custom home design and build process. Another seminar represents custom home selling techniques and is based on selling a first 1,000 custom homes at no profit followed by selling a second 1,000 homes with predictable process and good profits.

A third seminar represents understanding custom homebuyers 302 and teaches students about varying personalities and how emotions can both add to and take away from successful projects. Understanding customers is considered of prime importance.

Another seminar is directed to marketing the small homebuilding company. This seminar teaches marketing a business with actual marketing plans and procedures that approach the market from several directions, including advertising, promotion and networking.

Yet another seminar teaches the student to understand custom homebuilders 304 and the custom home industry, generally. This seminar preferably describes the homebuilding industry and functions of a well-grounded business to include: philosophy, organization, responsibility and accountability.

Another seminar teaches the student to accurately estimate costs and take advantages of fixed pricing. Students are preferably taught how small builders can survive bidding on fixed priced contracts and make money. Also, home-building materials and supplies are provided at low prices by passing on to the student a part of the savings for the proprietor's massive buying power. This seminar is about making on-target estimates that interact with System C's pricing center and the computer-based pricing and plans that provide detailed costs right down to the last screw and nail.

Another seminar teaches the student to create a successful custom homebuilding business through communications. A large amount of builder/buyer issues stem from the lack of communications, and projects must have a verifiable means to log and track all communications. By comparing what works to what does not work, builders learn how to create and manage a custom homebuilding company.

Another seminar represents legal issues faced by custom homebuilders. This seminar focuses on legal risks and perils of single-dwelling homebuilding, and how to avoid them with disclaimers that all builders should use.

Another seminar teaches steps to providing a quality home project with proper specifications. Construction techniques are preferably provided that put builders in a league of their own. When the steps are followed precisely, builders are taught how to increase profits while delivering better homes. This seminar shares a few simple tasks that improve construction standards with little added costs.

Yet another seminar teaches how to profit from designing homes. The designer of a home is believed to make or break a custom home builder. This seminar teaches builders to insist on homebuyers furnishing properly designed house plans or at the very least helping builders learn how to accurately price a poorly designed house.

Yet another seminar teaches fallacies in custom homebuilding. Every builder needs to understand that fallacies exist, and builders are taught how to overcome fallacies by using common sense decision making skills.

Another seminar teaches students to understand the emotional element in building custom homes as part of the 40-20-40 rule: Forty percent (40%) of issues between buyers and builders stem from the point of clearing the site and warranty work on the completed home. Sixty percent (60%) of all issues stem from the point the home was a dream until the lot is cleared. Plans, specs, codes and building inspectors help defined and direct the 40% of construction issues, but nothing currently exists for the remaining 60%. There are believed to be 1,269 critical problem points faced in every custom home project. Sixty percent of them lead to or cause emotional issues. Builders, functioning independently-own their own-cannot solve all of these issues. However, by being aware how the emotional components interfere with successful projects is a great step forward.

Thus, as described above, many kinds of seminars are available to train builders, buyers, vendors and management platform personnel in the processes associated with the present invention. Further, throughout the seminars dozens of check-sheets and step-by-step procedures are provided to the students. Moreover, computerized testing is preferably provided in the physical academy, the on-line training program, or both.

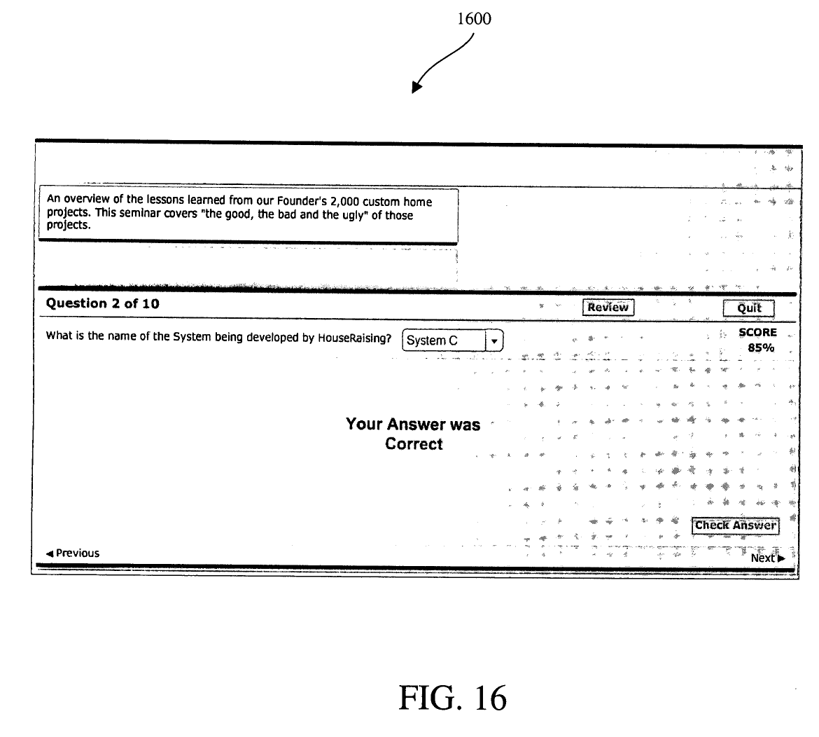

FIG. 16 illustrates an example test display screen 1600 that is used to gauge a student's or trainee's knowledge of a particular subject area. In a preferred embodiment, users of System C are precluded from operating System C in a working environment until the user demonstrates sufficient proficiency therein. Tests, such as shown in FIG. 16, are useful to measure such user competence.

Thus, the present invention includes a training and education component that is provided either in a university type setting or, alternatively, remotely over an on-line communication network.

Further, it is envisioned that the academy of the present invention will provide hands-on training for builders and vendors in the respective skills required for a custom home design and build project. For example, clearing or trimming a site, making a foundation level, providing electrical services, etc., are taught in a hands-on real-world environment that enables builders and vendors to obtain skills that comply with standards that exceed local rules.

Preferably a starting point selection is made from standard house designs, data representing the design, including square footage, style and costs are preferably provided. These data are used to create unique home plans and to solicit new business, to generate accurate estimates of the costs for building a custom home, and to complete the sale of a custom designed and built home project. Moreover, an interface is provided for a user of the present invention to define project management, including scheduling appointments, establishing contact information, defining features of a new custom homebuilding project, pricing information, building site information, financial and borrowing arrangements, and for outputting information for a custom homebuilder customer.

Further, an interface is provided to define the scope of a project, including preliminary sales analysis, fees associated with various phases of development, upgrade descriptions, and available credits (if any). Moreover, an interface for building plot information, including layout, budgeted allowances, layouts and illustrations, building permit requirements and associated costs, and comparisons of budgeted allowances and site requirements. Display screens are preferably associated with an interface provided for a 30-day pre-closing information, including general information, information for a regional financial manager, and for a budget department. Further, customized “dashboard” views are preferably provided in accordance with a preferred embodiment of the present invention. The dashboard view allows, at a glance, tasks, appointments, calendar, costs, and/or issues that may be associated with a respective custom homebuilding project. Further, display screens that are associated with closing on a custom homebuilding project are preferably provided. For example, any adjustments to the standard budget can be made via data entry forms, together with explanations for doing so. Information is preferably provided for the regional financial manager, budget department, contract coordinator, and builder. By enabling these parties to review and/or provide information at or before closing, the present invention enables parties associated with custom homebuilding to avoid unpleasant surprises and other undesirable consequences, often associated with the closing process. Moreover, meeting and scheduling information with an integrated e-mail client is preferably provided, charts indicating performance are displayed, and an on-line glossary is preferably provided that enables on-line access to many terms used in the custom homebuilding industry.

Preferably, the present invention is useful to enable the successful completion of a custom home building project. It is recognized by the inventors that many nuances and potential complexities exist for those attempting to operate the system successfully. Accordingly, the present invention includes an education and training component, that may be internet-based, to provide support for the design/build and renovation industries wishing to be availed of the features of the present invention. In particular, an education component is provided that identifies the who, what, how, when, where and why of the thousands of tasks associated with each custom home building project, as described in detail in the '569 patent application. By training buyers 302, builders 304, vendors 306, and/or MP1-6 personnel (308-318) to properly understand the system and methods defined in the '569 patent application and herein, the present invention ensures that the tasks associated with the design/build and renovation industries are completed successfully each and every time.

Although the present invention has been described in relation to particular embodiments thereof, many other variations and modifications and other uses will become apparent to those skilled in the art. It is preferred, therefore, that the present invention not be limited by the specific disclosure herein.

What is claimed is:

1. A method for using a database to sell a custom home design and build project to a buyer, the method comprising:
storing first electronic construction information related to specifications and costs associated with a plurality of custom home design and build projects in the database;
storing second electronic construction information related to specifications and costs associated with custom features for the plurality of the projects in the database;
defining buyer rules to be applied in selling one of the projects, wherein the buyer rules include:
obtaining buyer financial information from the buyer that represents the financial ability of the buyer;
obtaining personal information from the buyer that represents whether the buyer is personally able to purchase the one project;
retrieving from the database first electronic construction information related to the one project;
retrieving from the database second electronic construction information related to at least one custom feature to be included in the project; and
determining whether the buyer is able to afford the one project financially;
storing in the database electronic buyer rule information representing the buyer rules, and formatting the electronic buyer rule information to be retrievable upon request; and
training a party selling the one project to learn and apply buyer rules, wherein the training includes displaying the electronic buyer rule information on a computing device, wherein the party sells the one project to the buyer by applying the buyer rules and determining that the buyer is personally and financially able to purchase the one project.

2. The method of claim 1, further comprising:
defining construction rules for design and construction of custom homes, wherein the rules define labor and materials associated with the design and construction of the custom homes;
storing in the database electronic construction rule information representing the construction rules, and formatting the electronic construction rule information to be retrievable upon request;
training parties providing labor and materials associated with designing or constructing the one project to learn and apply the construction rules, wherein the training includes displaying the electronic construction rule information on a computing device; and
using the database to ensure that the one project is constructed in accordance with the construction rules.

3. The method of claim 1, further comprising:
defining management rules to be applied during a sale and construction of the one project, wherein the management rules define:
storing buyer information in the database representing the buyer;
storing construction information in the database representing the retrieved first electronic construction information and the retrieved second electronic construction information;
storing modified construction information representing changes to the construction information that occurred as a result of modified selections of the first electronic construction information and of modified selections of the second electronic construction information;
storing labor and materials information in the database representing labor and materials used in the one project; and
instructions for the parties associated with the one project as a function of the buyer information, the construction information, the modified construction information and the labor and materials information; and
storing in the database electronic management rule information representing the management rules, and formatting the electronic management rule information to be retrievable upon request;
training parties managing the one project to learn and apply the management rules, wherein the training includes displaying the electronic management rule information on a computing device; and
using the database to ensure that the one project is managed in accordance with the management rules.

4. The method of claim 1, wherein the personal information represents whether the buyer owns a building lot or has a building lot under contract.

5. The method of claim 4, wherein the personal information further represents whether the building lot is level or whether the building lot is elevated at least four feet above a road adjacent to the building lot.

6. The method of claim 1, wherein the personal information represents whether the buyer has expectations that are commensurate with the one project.

7. The method claim 1, wherein the training further comprises:
providing a training academy that includes at least one classroom equipped with at least computing device, wherein the buyer rules are trained in the classroom.

8. The method of claim 7, wherein the training academy further provides training to parties in the home building industry in rules defining labor and materials associated with the design and construction of the plurality of projects.

9. The method of claim 7, further comprising certifying the parties in the labor and materials associated with the design and construction of the plurality of projects.

10. The method of claim 1, wherein the training is provided as text or in a multimedia format.

11. The method of claim 1, wherein the training further provides interactive testing to ensure that the party understands the buyer rules.

12. A system for using a database to sell a custom home design and build project to a buyer, the method comprising:
a first electronic construction information module operable to store information related to specifications and costs associated with a plurality of custom home design and build projects in the database;
a second electronic construction information module related to specifications and costs associated with custom features for the plurality of the projects in the database;
buyer rules that are applicable during selling one of the projects, wherein the buyer rules include:
obtaining buyer financial information from the buyer that represents the financial ability of the buyer;
obtaining personal information from the buyer that represents whether the buyer is personally able to purchase the one project;
retrieving from the database first electronic construction information related to the one project;
retrieving from the database second electronic construction information related to at least one custom feature to be included in the project; and
determining whether the buyer is able to afford the one project financially;
electronic buyer rule information module operable to store in the database electronic buyer rule information representing the buyer rules, and further operable to format the electronic buyer rule information to be retrievable upon request; and
a training module operable to train a party selling the one project to learn and apply buyer rules, wherein the training module displays the electronic buyer rule information on a computing device, wherein the party sells the one project to the buyer by applying the buyer rules and determining that the buyer is personally and financially able to purchase the one project.

13. The system of claim 12, further comprising:
construction rules for design and construction of custom homes, wherein the rules define labor and materials associated with the design and construction of the custom homes;
an electronic construction rule information module operable to store electronic construction rule information representing the construction rules, and operable to format the electronic construction rule information to be retrievable upon request, wherein the training module is further operable to train parties providing labor and materials associated with designing or constructing the one project to learn and apply the construction rules, wherein the training module further displays the electronic construction rule information on a computing device, and further wherein the database is used to ensure that the one project is constructed in accordance with the construction rules.

14. The system of claim 12, further comprising:
management rules to be applied during a sale and construction of the one project, wherein the management rules define:
storing buyer information in the database representing the buyer;
storing construction information in the database representing the retrieved first electronic construction information and the retrieved second electronic construction information;
storing modified construction information representing changes to the construction information that occurred as a result of modified selections of the first electronic construction information and of modified selections of the second electronic construction information;
storing labor and materials information in the database representing labor and materials used in the one project; and
instructions for the parties associated with the one project as a function of the buyer information, the construction information, the modified construction information and the labor and materials information; and
an electronic management rule information module operable to store in the database electronic management rule information representing the management rules, and further operable to format the electronic management rule information to be retrievable upon request, wherein the training module is further operable to train parties managing the one project to learn and apply the management rules, wherein the training module further displays the electronic management rule information on a computing device, and further wherein the database is used to ensure that the one project is managed in accordance with the management rules.

15. The system of claim 12, wherein the personal information represents whether the buyer owns a building lot or has a building lot under contract.

16. The system of claim 15, wherein the personal information further represents whether the building lot is level or whether the building lot is elevated at least four feet above a road adjacent to the building lot.

17. The system of claim 12, wherein the personal information represents whether the buyer has expectations that are commensurate with the one project.

18. The system claim 12, wherein the training module further comprises:
a training academy that includes at least one classroom equipped with at least computing device, wherein the buyer rules are trained in the classroom.

19. The system of claim 18, wherein the training academy further provides training to parties in the home building industry in rules defining labor and materials associated with the design and construction of the plurality of projects.

20. The system of claim 18, wherein the training academy certifies parties in labor and materials associated with the design and construction of the plurality of projects.

21. The system of claim 12, wherein the training module further provides text or multimedia content.
